(19) United States
(12) Patent Application Publication
(10) Pub. No.: US 2026/0098109 A1
(43) Pub. Date: Apr. 9, 2026

(54) PROCESSES AND PROCESSING PLANTS FOR THE REMOVAL OF CATALYSTS USED IN THE MANUFACTURE OF POLYISOBUTYLENE AND HIGHLY REACTIVE POLYISOBUTYLENE

(71) Applicant: NTP Tec, LLC, Boerne, TX (US)

(72) Inventors: Clyde Edward BAXTER, Jr., League City, TX (US); Mark ROLL, Boerne, TX (US); Billy W. WAYCASTER, Cypress, TX (US)

(21) Appl. No.: 19/349,792

(22) Filed: Oct. 3, 2025

Related U.S. Application Data
(60) Provisional application No. 63/704,518, filed on Oct. 7, 2024.

(51) Int. Cl. C08F 110/10; C08F 4/14

(52) U.S. Cl. CPC C08F 110/10; C08F 4/14

(57) ABSTRACT

Embodiments described herein generally relate to new processes and processing plants for producing PIB, such as HR-PIB. In an embodiment, a process for producing HR-PIB is provided. The process includes introducing isobutylene into a polymerization reactor, and introducing a polymerization catalyst with the isobutylene to form a mixture comprising the isobutylene and the polymerization catalyst, the polymerization catalyst comprising a Lewis acid catalyst. The process further includes reacting the mixture to form a reaction product mixture comprising an HR-PIB, and introducing a solid substrate with the reaction product mixture, the solid substrate capable of sorbing an amount of polymerization catalyst. The process further includes removing the solid substrate comprising sorbed polymerization catalyst from the reaction product mixture by solid-liquid separation.

### CROSS-REFERENCE TO RELATED APPLICATIONS

This applications claims benefit of and priority to U.S. Provisional Patent Application Ser. No. 63/704,518, filed on Oct. 7, 2025, which is incorporated herein by reference in its entirety.

### FIELD

Embodiments of the present disclosure generally relate to new processes and processing plants for producing polyisobutylene (PIB), such as highly reactive polyisobutylene (HR-PIB).

### BACKGROUND

HR-PIB is a polymer used in various applications, including lubricants, fuel and lubricant additives, and sealants, among other applications. One of the most efficient catalysts for HR-PIB production is a liquid boron trifluoride (BF₃) complex, such as BF₃-methanol (BF₃·MeOH) complex. BF₃ complexes provide significant advantages over conventional catalysts that use higher molecular weight alcohols or ethers, mainly due to their stability. The stability of BF₃·MeOH complexes stems from the absence of beta hydrogen atoms which prevents beta-elimination reactions—a common issue observed with other BF₃ complexes. This makes BF₃·MeOH a useful polymerization catalyst for the polymerization of isobutylene, yielding a product with high alpha-vinylidene content, a critical requirement for HR-PIB.

However, a persistent challenge in the use of BF₃·MeOH, other liquid BF₃ complexes, as well as other Lewis acids is the removal of the polymerization catalyst from the reaction product mixture after polymerization. Conventional catalyst removal methods involve subjecting the reaction product mixture to water washing and/or solvent extraction, both of which create substantial operational challenges and environmental burdens. Water washes generate large volumes of wastewater contaminated with species such as fluoride or chloride residues. Solvent extractions introduce volatile organic compounds (VOCs) into the waste streams. Not only do conventional catalyst removal practices significantly increase capital and operational costs due to the need for waste management, conventional catalyst removal practices also raise environmental concerns regarding the disposal of toxic byproducts and materials.

There is a need for new processes for producing PIB, such as HR-PIB. There is also a need for new processing plants for producing PIB, such as HR-PIB.

### SUMMARY

Embodiments described herein generally relate to new processes and processing plants for producing PIB, such as HR-PIB. Generally, embodiments of the present disclosure provide for novel processes and processing schemes for catalyst removal by sorbing a polymerization catalyst (for example, a liquid BF₃ catalyst complex) onto a solid substrate, thereby eliminating the need for conventional water washes or solvent-based separation methods on the reaction product mixture produced from the polymerization. The solid substrates have the capacity to sorb the polymerization catalyst, ensuring efficient removal, or at least partial removal, of the polymerization catalyst from the reaction product mixture.

Embodiments described herein provide significant improvements in PIB and HR-PIB manufacturing processes. For example, embodiments of the present disclosure may simplify catalyst removal, reduce waste, lower overall production costs. The use of solid substrates may help ensure that at least a portion of the polymerization catalyst may be efficiently sorbed before, during, and/or after the polymerization reaction to form HR-PIB. Once sorbed, the sorbed polymerization catalyst may be removed by any suitable solid-liquid separation technique, which may reduce residual fluoride content in the product to, for example, less than 10 ppm. This not only eliminates the need for water washing and solvent extraction but also minimizes the environmental impact while maintaining the integrity of the HR-PIB product. Embodiments of the present disclosure are poised to advance HR-PIB production by providing a more sustainable and cost-effective process for producing HR-PIB. Embodiments described herein address the environmental and operational challenges associated with handling unstable and/or toxic Lewis acid catalysts such as BF₃ (a gas) and AlCl₃. Further, embodiments described herein may be utilized to enhance the overall efficiency of the HR-PIB manufacturing process while ensuring that the high-quality standards of HR-PIB production, particularly its high alpha-vinylidene content, may be consistently met.

In an embodiment, a process for producing highly HR-PIB is provided. The process includes introducing isobutylene into a polymerization reactor. The process further includes introducing a polymerization catalyst with the isobutylene to form a mixture comprising the isobutylene and the polymerization catalyst, the polymerization catalyst comprising a Lewis acid catalyst. The process further includes reacting the mixture to form a reaction product mixture comprising an HR-PIB. The process further includes introducing a solid substrate with the reaction product mixture, the solid substrate having a capacity to (or capable of) sorbing an amount of polymerization catalyst such that the resultant solid substrate comprising sorbed polymerization catalyst has a concentration of the polymerization catalyst that is about 1 wt % or more (calculated as wt % of Lewis acid catalyst) based on a total wt % of the solid substrate comprising sorbed polymerization catalyst, the total wt % of the solid substrate comprising sorbed polymerization catalyst equal to 100 wt %. The process further includes removing the solid substrate comprising sorbed polymerization catalyst from the reaction product mixture by solid-liquid separation.

In another embodiment, a process for producing highly HR-PIB is provided. The process includes feeding an isobutylene-containing stream into a polymerization reactor. The process further includes injecting an amount of polymerization catalyst into the polymerization reactor to form a mixture comprising isobutylene and polymerization catalyst, the amount of polymerization catalyst sufficient to catalyze an isobutylene polymerization reaction to form HR-PIB, the polymerization catalyst comprising a Lewis acid catalyst. The process further includes introducing a solid substrate with the mixture, the solid substrate capable of sorbing an amount of the polymerization catalyst such that the resultant solid substrate comprising sorbed polymerization catalyst has a concentration of polymerization catalyst that is about 1 wt % or more (calculated as wt % of Lewis acid catalyst), wherein the solid substrate is introduced before, during, and/or after the isobutylene polymerization reaction. The process further includes removing the solid substrate comprising sorbed polymerization catalyst from the mixture by solid-liquid separation.

In another embodiment, a processing plant for producing HR-PIB is provided. The processing plant includes a tubular loop reactor configured to perform isobutylene polymerization, form a reaction product mixture comprising HR-PIB, and discharge the reaction product mixture comprising the HR-PIB. The processing plant further includes a tubular loop sorber coupled to the tubular loop reactor and positioned downstream from the tubular loop reactor, the tubular loop sorber equipped with one or more in-line circulation pumps and a multi-pass tube-in-shell heat exchanger, the tubular loop sorber configured to receive the reaction product mixture from the tubular loop reactor, facilitate sorption of a polymerization catalyst present in the reaction product mixture onto a solid substrate, and discharge the reaction product mixture comprising the HR-PIB and the solid substrate comprising sorbed polymerization catalyst. The processing plant further includes a solid-liquid separation unit coupled to the tubular loop sorber and positioned downstream from the tubular loop sorber, the solid-liquid separation unit configured to separate the solid substrate comprising sorbed polymerization catalyst from the reaction product mixture, discharge the solid substrate comprising sorbed polymerization catalyst, and discharge an HR-PIB containing filtrate.

In another embodiment, a process for producing HR-PIB is provided. The process includes introducing a polymerization catalyst with isobutylene to form a mixture comprising the isobutylene and the polymerization catalyst, the polymerization catalyst comprising a Lewis acid catalyst. The process further includes reacting the mixture to form a reaction product mixture comprising an HR-PIB. The process further includes sorbing the polymerization catalyst onto a solid substrate, the resultant solid substrate comprising sorbed polymerization catalyst having a concentration of the polymerization catalyst that is about 1 wt % or more (calculated as wt % of Lewis acid catalyst) based on a total wt % of the solid substrate comprising sorbed polymerization catalyst, the total wt % of the solid substrate comprising sorbed polymerization catalyst equal to 100 wt %. The process further includes removing the solid substrate comprising sorbed polymerization catalyst from the reaction product mixture by solid-liquid separation.

In another embodiment, a process for producing HR-PIB is provided. The process includes feeding an isobutylene-containing stream into a polymerization reactor. The process further includes injecting an amount of polymerization catalyst into the polymerization reactor to form a mixture comprising isobutylene and polymerization catalyst, the amount of the polymerization catalyst sufficient to catalyze an isobutylene polymerization reaction to form HR-PIB, the polymerization catalyst comprising a Lewis acid catalyst. The process further includes sorbing the polymerization catalyst onto a solid substrate, the resultant solid substrate comprising sorbed polymerization catalyst having a concentration of the polymerization catalyst that is about 1 wt % or more (calculated as wt % of Lewis acid catalyst) based on a total wt % of the solid substrate comprising sorbed polymerization catalyst, the total wt % of the solid substrate comprising sorbed polymerization catalyst equal to 100 wt %, wherein sorbing the polymerization catalyst onto the solid substrate occurs before, during, and/or after the isobutylene polymerization reaction. The process further includes removing the solid substrate comprising sorbed polymerization catalyst from the mixture by solid-liquid separation.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limited of its scope, and may admit to other equally effective embodiments.

FIG. 1 is a generalized schematic flow diagram showing various implementations of processes to produce PIB, for example, HR-PIB, according to at least one embodiment of the present disclosure.

FIG. 2 is a generalized schematic flow diagram showing various implementations of processes to produce PIB, for example, HR-PIB, according to at least one embodiment of the present disclosure.

FIG. 3 shows selected operations of a process for producing PIB, for example, HR-PIB, according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to new processes and processing plants for producing PIB, such as HR-PIB. The inventors found novel and highly efficient for removing polymerization catalyst removal in the manufacturing of PIB. In general, for example, the catalyst utilized to polymerize isobutylene may be rapidly sorbed onto a solid substrate and the solid substrates having sorbed polymerization catalyst may be removed from the reaction product mixture containing the HR-PIB by any suitable solid-liquid separation technique. Embodiments described herein overcome traditional challenges associated with catalyst removal in HR-PIB production. Historically, the separation and removal of polymerization catalysts requires laborious and environmentally detrimental methods, such as water washes or polar solvent extraction, both of which generate large volumes of wastewater containing problematic substances such as fluoride residues, chloride residues, and volatile organic compounds (VOCs). Such conventional processes lead to elevated capital and operating expenses and pose significant environmental concerns. In contrast to conventional technologies, and advantageously, embodiments of the present disclosure eliminate the need for costly and environmentally unacceptable water washing and solvent extraction techniques to remove the polymerization catalysts.

HR-PIB is a composition that includes greater than about 75% alpha vinylidene olefin isomer. PIB having large amounts of alpha vinylidene olefin content are termed HR-PIB because the reactivity in the derivative reactions, particularly to make fuel and lubricant additives, is greatly enhanced.

HR-PIB compositions described herein may contain additional olefin isomers including beta vinylidene olefin isomer, other trisubstituted olefin isomers, internal vinylidenes, and tetrasubstituted olefin isomers. As used herein, a “composition” may include component(s) of the composition, reaction product(s) of two or more components of the composition, a remainder balance of remaining starting component(s), or combinations thereof. HR-PIB is termed highly reactive because of its increased reactivity in derivatization reactions, such as reactions with maleic anhydride to produce polyisobutenylsuccinic anhydride (PIBSA) to form precursors useful for fuel and lubricant additives.

Conventional polyisobutylene (cPIB), in contrast to HR-PIB, has a majority of its olefin isomers other than alpha vinylidene. cPIB typically has 10% or less of alpha vinylidene olefin isomer and is therefore significantly less reactive in derivatization reactions than HR-PIB.

The alpha vinylidene olefin isomer (also referred to as α-vinylidene) of a PIB composition (or HR-PIB composition) may be represented by formula (IA):

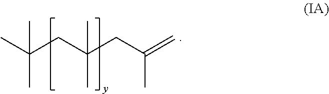

As shown in formula (IA), alpha vinylidene has the double bond (or olefin) positioned in the terminal position of the molecule, allowing it to react more quickly when producing derivatives. As described herein, HR-PIB includes greater than about 75% alpha vinylidene olefin isomer whereas cPIB has about 10% or less of alpha vinylidene olefin isomer.

The beta vinylidene olefin isomer (also referred to as β-vinylidene) of a PIB composition (or HR-PIB composition) may be represented by formula (IB):

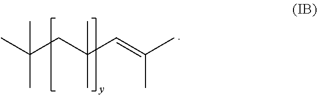

An internal disubstituted vinylidene olefin isomer of a PIB composition (or HR-PIB composition) may include the following structure represented by formula (IC):

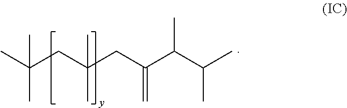

Other internal vinylidenes are possible, including where the position of the olefin in the polyisobutylene is such that the olefin is disubstituted and not at the end of the carbon chain. Other trisubstituted olefin isomers and tetrasubstituted olefin isomers may be produced in the polymerizations described herein.

State-of-the-art HR-PIB production uses Lewis acid catalyst complexes such as liquid BF₃ catalyst complexes. These liquid BF₃ catalyst complexes are unstable, breaking down into non-reactive species at normal operating temperatures and pressures and are made in situ from BF₃ gas and the corresponding alcohol and/or ether on-site at the polymerization facility. BF₃ gas is highly toxic and represents a substantial risk to operational personnel and thus requires a significant capital investment to meet all safety and environmental requirements. Liquid catalysts, such as the liquid BF₃ catalyst complexes, however, must be quenched post reaction by water washing. Water washing is very difficult, requiring many additional downstream operations, including a series of large mixer/settler units generating copious amounts of wastewater containing fluorides that must be disposed. Liquid catalyst removal, therefore, is a significant bottleneck and represents a substantial capital and operational expense in traditional HR-PIB production.

Various methods for forming PIB exist. For example, a first conventional method for forming PIB includes an isobutylene polymerization processes using stable BF₃ complexes sorbed on substrates as slurry catalysts. Although the HR-PIB produced by this first conventional method meets industry standards, preparing the catalyst may be cumbersome and unsuitable for continuous reactions. Additionally, the desirable chemical properties and activity of the liquid BF₃ catalyst complex in this first conventional method may be altered and diluted, requiring higher catalyst concentrations and higher catalyst costs, resulting in higher operating costs.

A second conventional method of forming PIB includes the use of BF₃·MeOH complexes sorbed on pure alumina substrates packed in fixed-bed reactors as catalysts for isobutylene polymerization. The catalysts in this second conventional method remain in the reactor and do not need to be removed by washing or extraction procedures after the reaction. However, PIB produced by this second conventional method is not true HR-PIB as it does not contain greater than 75% alpha vinylidene olefin isomer. These PIB polymers, instead, contain significant quantities of internal vinylidene isomers that are not sufficiently reactive in the PIB derivatization reactions used to make fuel and lubricant additives.

These conventional approaches involve adding the liquid BF₃ catalyst complexes to the substrate prior to the reaction. In contrast, embodiments of the present disclosure may include adding the solid substrate to sorb the polymerization catalyst (for example, a liquid BF₃ complex) after the polymerization reaction and, as such, are not available to dilute the activity of the catalyst and/or otherwise interfere with the polymerization reaction.

A third conventional method for forming PIB includes the use pure alumina substrates as solid deactivators for liquid BF₃ catalyst complexes used in isobutylene polymerization reactions to make HR-PIB. High ratios of alumina to the BF₃ catalyst complex are used to completely deactivate the BF₃ catalyst complexes to avoid side reactions catalyzed by the BF₃ complexes sorbed on the substrate at the higher ratios of BF₃ complex to alumna substrate, including the isomerization of the alpha vinylidene to lower reactive internal vinylidene isomers. Stopping the reaction is required by the third conventional method because long contact times are utilized, which would allow time for the unwanted side reactions to occur. In the third conventional method, the alumina is slurried batch-wise with the crude reaction mixture containing the catalyst for 90 minutes at a substrate to catalyst ratio of over 500 to 1.

The third conventional method also utilizes a processing scheme in which the pure alumina substrate is packed in a column. As the crude HR-PIB containing reaction mixture flows through the column, the substrate sorbs the liquid BF₃ catalyst complex. The data from this operation shows that only about 75% of the catalyst is removed (as measured by the amount of F removed) and decreases with each cycle. Furthermore, this processing scheme of the third conventional method is problematic because the BF₃ complex tends to saturate the substrate from bottom to top (or top to bottom, depending on flow direction) until the entire column is saturated. The saturated substrate would always be catalytic, weakly catalytic at first, and then increasing in catalytic activity as more and more of the column becomes saturated. As mentioned above, this undesired catalytic activity leads to side reactions and potential isomerization of the olefin end groups, reducing the amount of alpha vinylidene. Packed columns are, therefore, not desirable for deactivating and/or removing catalytic species from a reaction mixture.

Catalyst removal processes of the present disclosure are significantly advantaged over the third conventional method. For example, the amount of solid substrate used for embodiments described herein may be orders of magnitude less than that required by the third conventional method. Further, embodiments described herein may use a sorption time of less than 4 minutes, which is significantly less than the 90 minutes used in third conventional method.

In various implementations, embodiments described herein may include use of a novel tubular loop sorber to effectively contact the catalyst with the solid substrate in a minimum amount of time. Other sorbers besides tubular loop sorbers are contemplated.

In some embodiments, which may be combined with other embodiments, the solid substrate may be co-fed with the polymerization catalyst (e.g., liquid BF₃ catalyst complex) and/or otherwise added to the polymerization reactor so that the polymerization catalyst (e.g., liquid BF₃) sorption may occur in situ, taking advantage of the high velocity of the mixture comprising isobutylene and polymerization catalyst in reactor tubes to effect complete and rapid sorption of the polymerization catalyst (e.g., liquid BF₃) by the solid substrate.

Using large excesses of solid substrate is not necessary to deactivate the polymerization catalyst and stop the reaction (though utilization of excess solid substrate is contemplated). In addition, embodiments described herein may be used to remove all (or substantially all) traces of the BF₃ catalyst complexes to a fluoride content of less than 10 ppm, eliminating the need for additional downstream fluoride removal columns.

In contrast to conventional technologies, embodiments described herein include the elimination of conventional catalyst removal techniques by introducing a solid substrate capable of sorbing a targeted amount of the polymerization catalyst, for example, BF₃ catalyst complex. This sorption capability may help ensure almost complete and rapid removal of the polymerization catalyst from the reaction product mixture, providing significant cost and environmental advantages over existing methods. The flexibility of processes described herein may lie, for example, in its ability to add the solid substrate at one or more of at least three distinct stages: before, during, and/or after the isobutylene polymerization reaction, each stage offering specific operational advantages. Similarly, processes described herein have the ability to add the solid substrate at one or more locations relative to the polymerization reactor: upstream of the polymerization reactor, in the polymerization reactor, and/or downstream from the polymerization reactor.

Addition of the solid substrate before the polymerization reaction and/or contacting the polymerization catalyst with the solid substrate upstream of the polymerization reactor. In this approach, for example, the polymerization catalyst (e.g., BF₃ catalyst complex) may be pre-sorbed or pre-impregnated onto the solid substrate before the polymerization reaction takes place. This pre-made solid catalyst may, for example, be co-fed into the polymerization reactor along with the isobutylene-containing feed. The solid substrate-bound catalyst may allow for precise control of the catalytic activity, as the polymerization catalyst (e.g., BF₃ catalyst complex) is already immobilized on the solid substrate.

Addition of the solid substrate during the polymerization reaction and/or contacting the polymerization catalyst with the solid substrate in the polymerization reactor. In this approach, for example, the solid substrate may be introduced during the polymerization reaction by co-feeding it with the polymerization catalyst (e.g., liquid BF₃ catalyst complex), or by directly injecting the solid substrate into the polymerization reactor such as a tubular loop reactor. As the isobutylene-containing feed enters the tubular loop reactor, the polymerization catalyst (e.g., liquid BF₃ catalyst complex) and solid substrate interact in situ. This approach may offer the advantage of real-time sorption, ensuring that the polymerization catalyst (e.g., liquid BF₃ catalyst complex) may be rapidly captured by the solid substrate while the polymerization is occurring. The high flow velocity and turbulence within the tubular loop reactor may facilitate thorough mixing, promoting quick sorption of the polymerization catalyst (e.g., liquid BF₃ catalyst complex) onto the solid substrate before the reaction product mixture proceeds to the sorption unit or separation step. This approach may be highly efficient, as it may prevent catalyst loss and may ensure continuous operation with minimal catalyst contamination in the product stream.

Addition of the solid substrate after the polymerization reaction and/or contacting the polymerization catalyst with the solid substrate downstream from the polymerization reactor. In this approach, for example, the solid substrate may be introduced after the polymerization reaction in a separate sorber. Here, for example, the crude reaction product mixture comprising the PIB, which still contains the polymerization catalyst (e.g., liquid BF₃ catalyst complex), may flow into the sorber, such as a tubular loop sorber, where the solid substrate may be added. The solid substrate may rapidly sorb the polymerization catalyst (e.g., liquid BF₃ catalyst complex) from the reaction product mixture. The sorption unit may be designed with suitable flow dynamics to ensure that the polymerization catalyst (e.g., BF₃ catalyst complex) may be fully captured (or at least partially captured) by the solid substrate within, e.g., less than 4 minutes, allowing for efficient downstream processing. Once the polymerization catalyst (e.g., BF₃ catalyst complex) is sorbed, the solid substrate comprising sorbed polymerization catalyst (e.g., sorbed BF₃ catalyst complex) may be separated from the reaction product mixture using conventional solid-liquid separation techniques such as filtration or centrifugation, ensuring that the final product stream may be free, or at least partially free, of catalyst residues.

Overall the polymerization catalyst may be sorbed on the solid substrate before the polymerization reaction (e.g., before introduction of the polymerization catalyst into the polymerization reactor), and the thus formed solid catalyst may be co-fed with the isobutylene or otherwise added to the polymerization reactor, and/or the polymerization catalyst (e.g., liquid BF₃ catalyst complex) and the solid substrate may be co-fed separately with the isobutylene-containing feed, and/or the polymerization catalyst (e.g., liquid BF₃ catalyst complex) may be co-fed with the isobutylene-containing feed and the solid substrate otherwise added directly to the polymerization reactor or the solid substrate may be mixed with the liquid catalyst after the reaction in a separate sorption unit or tank. In various embodiments, and regardless of the timing—e.g., before, during, and/or after—with respect to the polymerization reaction and/or regardless of location—upstream, within, and/or downstream—of the polymerization reactor, at least a portion of the polymerization catalyst should be sorbed by or onto the solid substrate before the solids separation (e.g., by continuous filtration or centrifugation) operation.

“Sorbed polymerization catalyst” refers to (1) adsorbed (for example, surface attached) polymerization catalyst, (2) absorbed polymerization catalyst, (3) or combinations thereof.

The use of headings is for purposes of convenience only and does not limit the scope of the present disclosure. Embodiments described herein may be combined with other embodiments.

### Processing Plants

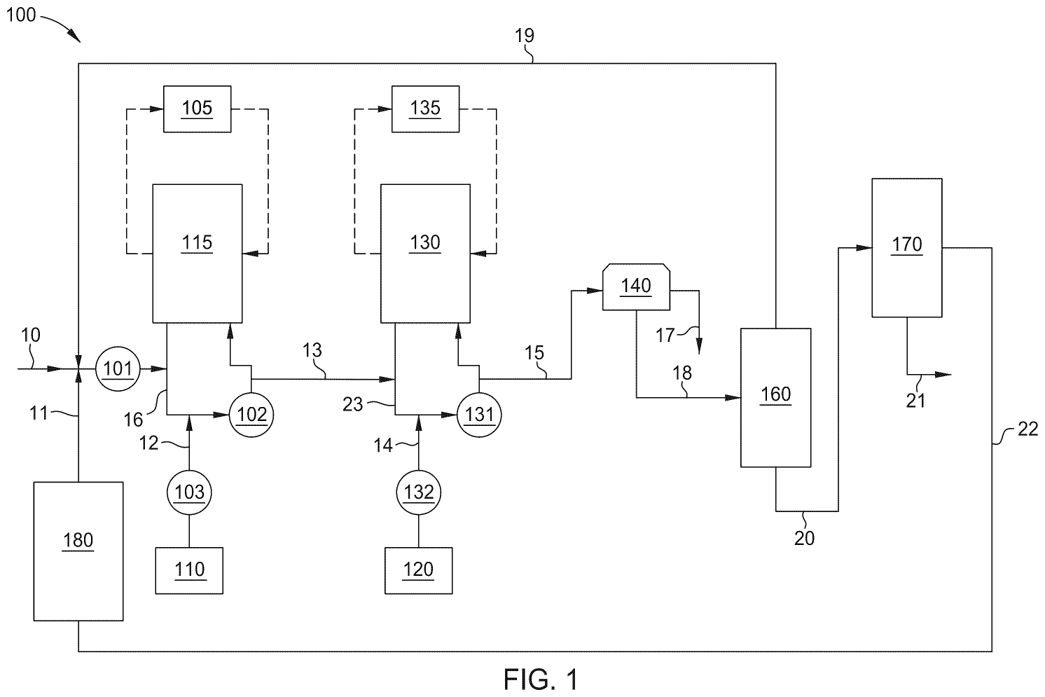

Embodiments of the present disclosure generally relate to systems or processing plants for producing PIB, for example, HR-PIB. FIG. 1 is a generalized schematic flow diagram of a processing plant 100 for implementing various processes described herein to produce PIB (for example, HR-PIB) described herein. Although processing plants of the present disclosure may be described with respect to producing HR-PIB, the processing plants may be utilized for producing PIB unless the context clearly indicates otherwise.

An isobutylene-containing feed, such as high-purity isobutylene, may be fed to a polymerization reactor 115 (such as a tubular loop reactor or other suitable reactor) via a pump 101 through line 10. The polymerization reactor 115 is configured to form PIB, such as HR-PIB. The isobutylene may be diluted to 85-95% with any suitable non-polar hydrocarbon diluent such as isobutane, hexane, or combinations thereof. An optional reactor circulation loop 16 may be coupled to the polymerization reactor 115. The mixture comprising isobutylene and polymerization catalyst present in the polymerization reactor 115 may be recirculated in the optional reactor circulation loop 16, for example, to provide high velocity, with use of an in-line circulation pump 102. Additionally, or alternatively, the isobutylene-containing feed may be fed directly to the polymerization reactor 115.

Polymerization catalyst unit 110 may hold polymerization catalyst described herein. For example, the polymerization catalyst may include a Lewis acid, such as BF₃, a BF₃ complex, and/or other suitable polymerization catalyst. The polymerization catalyst may be a liquid, a gas, a solid (such as powders), or combinations thereof. The polymerization catalyst may be injected or otherwise introduced into the polymerization reactor 115 via line 12 using an optional catalyst feed pump 103. Additionally, or alternatively, the polymerization catalyst may be fed directly to the polymerization reactor 115.

In the polymerization reactor 115, a mixture is formed that includes a polymerization catalyst and isobutylene. Upon reaction of the mixture, a crude reaction product mixture (also referred to herein as a reaction product effluent) comprising a polymer composition is formed. The polymer composition may be or include PIB, such as HR-PIB.

The polymerization reaction in polymerization reactor 115 is performed under conditions effective to form a reaction product mixture comprising the polymer composition. Suitable polymerization catalysts and polymerization conditions may include those described in U.S. Pat. Nos. 10,640,590, 11,124,585, 11,214,637, and 11,174,206, each of which is incorporated in its entirety to the extent consistent with embodiments of the present disclosure.

As an illustrative, but non-limiting, example, isobutylene (or an isobutylene-containing feed) flows into the polymerization reactor 115 (for example, a PIB reactor or an HR-PIB reactor) in which the mixture comprising isobutylene and polymerization catalyst may be recirculated in a tubular loop reactor at high linear velocities utilizing an in-line circulation pump 102. The tubular reactor may be of a tube-in-shell design. The polymerization reaction occurs in the tubes, and the cooling medium may be provided by an external chiller unit which flows on the shell side to control the polymerization reaction temperature. A polymerization catalyst may be injected via line 12 flowing from polymerization catalyst unit 110 with the assistance of an optional catalyst feed pump 103. The polymerization reaction is exothermic and takes place in the liquid phase in the polymerization reactor tubes at a pressure that may be greater than the autogenous pressure at the given reactor temperature, which may be in a range from about 100 psig (about 700 kPa) to about 150 psig (about 1,000 kPa). The reaction temperature may be controlled by coolant flow on a shell side of the polymerization reactor supplied by external cooling unit 105. The residence time in the polymerization reactor 115 may be determined by the isobutylene-containing feed rate, which is independent of the circulation rate provided by the in-line circulation pump 102. The reaction product mixture exiting the polymerization reactor 115 via line 13 includes PIB (for example, HR-PIB). The reaction product mixture may be a crude reaction mixture comprising HR-PIB and one or more optional components. The one or more optional components of the reaction product mixture may include unreacted isobutylene, hydrocarbon diluent (e.g., isobutane, hexane, or combinations thereof), catalyst residues, or combinations thereof. The one or more optional components of the reaction product mixture may be recycled to various units in the processing plant 100.

The polymerization catalyst may be injected (for example, via line 12) into the incoming isobutylene-containing feed flowing through line 10 and into the optional reactor circulation loop 16 at a point where the physical distance between the injection point in the feed line and the point at which the feed enters the polymerization reactor 115 may be at a minimum. The injection point for the polymerization catalyst may be on the suction side of the feed pump (for example, in-line circulation pump 102) to provide mixing. The polymerization catalyst may be introduced at a concentration sufficient to catalyze an isobutylene polymerization reaction.

The polymerization in the polymerization reactor 115 may be performed according to the following non-limiting procedure. A polymerization catalyst feed and an isobutylene-containing feed may be flowed into the polymerization reactor 115 to form a mixture comprising isobutylene and polymerization catalyst. The mixture comprising isobutylene and polymerization catalyst may be maintained at a temperature that may be in a range from about −35° C. to about 100° C., such as about 0° C. to about 80° C. The reaction may be carried out in the liquid phase at pressures of at least about autogenous pressures, such as in a range from about 100 psig (about 0.7 MPa) to about 150 psig (about 1.0 MPa). After a suitable period (for example, a residence time of the isobutylene in the polymerization reactor), a polymer composition is obtained. For example, the polymerization may be performed for about 30 minutes or less, such as about 10 minutes or less, such as about 4 minutes or less, such as about 2 minutes or less.

The polymerization reactor 115 may include any suitable reactor. Suitable polymerization reactors useful for the polymerization may include a batch reactor, a continuous flow reactor, a tank reactor, a tubular reactor, a tubular loop reactor, a continuous stirred tank reactor (CSTR), a plug flow reactor, a fluidized bed reactor, an immobilized bed reactor, a fixed bed reactor, or combinations thereof, such as such as a continuous flow reactor, a CSTR, a tubular reactor, a tubular loop reactor, or combinations thereof. The polymerization reactor may include more than one reactor which may be operated in series or parallel. The polymerization reactor(s) may or may not have internal cooling or heating, and the feeds to the polymerization reactor may or may not be refrigerated.

Times and temperatures may be controlled such that no significant olefin isomerization occurs during polymerization, and such that conversion and molecular weights are in desirable ranges. Reaction temperatures and pressures, and polymer precursor concentrations, may be selected to control for the Mn of the polymer composition. For example, higher temperatures typically provide polymer compositions with lower Mn.

Temperature control in the polymerization reactor 115 may be achieved by offsetting the heat of polymerization with reactor cooling by using reactor jackets or cooling coils to cool the contents of the polymerization reactor, auto refrigeration, pre-chilled feeds, vaporization of liquid medium (diluent, polymer precursors, or solvent) or combinations of all three. In the case of CSTR with ebullient cooling, the boiling mixture may be cooled with a chilled overhead condenser. For non-ebullient cooled CSTR, any suitable type of heat exchanger may be used to chill the reactor jacket using any suitable cooling media.

In some embodiments, a fast reactor is used. A fast reactor is one in which the reactor is the heat exchanger with the reaction taking place in the tubes with cooling on the shell. Any suitable type of cooling media may be used depending mainly on operating temperature range. Adiabatic reactors with pre-chilled feeds may also be used. In some embodiments, the reactor(s) for the polymerization may be operated in as much of an isothermal mode as possible. Non-isothermal reactor operation may result in broader molecular weight distributions. In series operation with two or more polymerization reactors, a second reactor temperature may be higher than a first reactor temperature. In parallel reactor operation, the temperatures of the two reactors may be independent.

For CSTR operations, a concentration of the polymerization catalyst in the mixture comprising isobutylene and polymerization catalyst may be from about 1,000 ppm to about 2,000 ppm based on a total weight of the polymerization catalyst feed (fed via line 12), wherein a Lewis acid concentration (e.g., BF₃) in the polymerization catalyst feed may be in a range from about 250 ppm to about 1,000 ppm, such as from about 250 ppm to about 500 ppm or from about 500 ppm to about 1,000 ppm based on the total weight of the polymerization catalyst feed. Residence times may be less than about 600 minutes, such as less than about 120 minutes, such as less than about 60 minutes, or in a range from about 5 minutes to about 600 minutes, such as from about 15 minutes to about 120 minutes, such as from about 30 minutes to about 60 minutes, and may be controlled by polymerization catalyst concentration. Higher polymerization catalyst concentrations may increase the reaction rate. The polymerization reaction may be highly exothermic and a limiting factor to reaction rate may be the ability to remove the heat of reaction.

In CSTR operations, the mixture comprising the polymerization catalyst and isobutylene may be flowing upward in the polymerization reactor, through at least a first portion of the polymerization reactor and a second portion of the polymerization reactor. The first portion of the polymerization reactor may be relatively narrow to provide higher velocity and higher polymerization catalyst mixing. The second portion of the polymerization reactor may be wider to provide lower velocity and less polymerization catalyst mixing. The reaction product mixture may exit near the top of the polymerization reactor with some polymerization catalyst being carried out with the exiting reaction product mixture. The polymerization catalyst exiting the polymerization reactor may be made up with polymerization catalyst from a polymerization catalyst injection such that a constant polymerization catalyst amount is maintained in the polymerization reactor. The reaction temperature may be maintained by vaporization of a portion of the isobutylene feed controlled by the reactor pressure. For example, a higher polymerization reactor pressure may give higher reaction temperature according to the vapor pressure curve of the system butylenes. Mn of the polymer composition may be controlled by reaction temperature with a higher reaction temperature giving lower Mn. Reaction temperatures in a range from about −5° C. to about 5° C. may provide polymer compositions having an Mn of about 2,300 Da. Reaction temperatures in a range from about 18° C. to about 22° C. may provide polymers having an Mn of about 900 Da to about 1,100 Da, such as about 1,000 Da.

For fast reactor modes, the polymerization reactor 115 may include tubular loop reactor. Here, the tubular loop reactor may include a tube-in-shell heat exchanger with the polymerization reaction taking place in the tubes and cooling provided through the shell side of the heat exchanger with the heat of the polymerization reaction taken out by an external chiller unit. A reactor design for polymerization reactor 115 may include a two-pass heat exchanger. The reaction may be carried out in the liquid phase at pressures of at least about autogenous pressures, typically greater than about 0 psig (0 kPa), such as in a range from about 35 psig to about 300 psig (about 250 kPa to about 2100 kPa), such as from about 100 psig to about 150 psig (about 700 kPa to about 1000 kPa).

A tubular loop reactor useful for the polymerization reactor 115 may include a multi-pass tube-in-shell heat exchanger configuration. Such a configuration supports the maintenance suitable reaction conditions. Other tubular loop reactors are contemplated and may include a single pass tube-in-shell heat exchanger configuration. The tubular loop reactor may be equipped with in-line circulation pumps that provide high flow rates, ensuring turbulent mixing and uniform dispersion of the catalyst and solid substrate. Temperature control may be achieved through the circulation of cooling media, which regulates the exothermic polymerization reaction and sorption processes. This thermal management may serve to enhance the stability and efficiency of the polymerization, preventing catalyst degradation and side reactions.

For a tubular loop reactor, a circulation loop may be provided to deliver high velocity in the tubes at a Reynolds number of the circulating liquid in the tubes that may be about 2,000 or more. Reynolds numbers of about 2,000 or more allow for turbulent flow in the tubes which increases the heat exchange and the ability to remove the heat of reaction in very short periods of time. The ability to quickly remove the heat of reaction allows for operation at very short residence times. A residence time of the mixture comprising the isobutylene and polymerization catalyst in the tubular loop reactor may be about 60 minutes or less, such as about 30 minutes or less, such as about 10 minutes or less, such as about 4 minutes or less, such as about 3 minutes or less, such as about 2 minutes or less, such as about 1 minute or less. Additionally or alternatively, a residence time of the mixture comprising the isobutylene and polymerization catalyst in the tubular loop reactor may be in a range from about 1 second to about 60 minutes, such as from about 5 seconds to about 30 minutes, such as from about 10 seconds to about 10 minutes, such as from about 30 seconds to about 4 minutes.

A concentration of the polymerization catalyst in the polymerization reaction mixture (e.g., the mixture comprising isobutylene and polymerization catalyst) may be from about 800 ppm to about 10,000 ppm based on a total weight of the polymerization reaction mixture, and wherein a BF₃ concentration in the polymerization reaction mixture is from about 500 ppm to about 7,250 ppm based on the total weight of the polymerization reaction mixture. Alternatively, the concentration of the polymerization catalyst in the polymerization reaction mixture may be from about 2,000 ppm to about 4,000 ppm based on a total weight of the polymerization reaction mixture, and wherein the BF₃ concentration in the polymerization reaction mixture may be between about 1,250 ppm to about 2,900 ppm based on the total weight of the polymerization reaction mixture. Alternatively, the concentration of the polymerization catalyst in the polymerization reaction mixture may be greater than about 800 ppm based on a total weight of the polymerization reaction mixture, and wherein the BF₃ concentration in the polymerization reaction mixture may be greater than about 500 ppm based on a total weight of the polymerization reaction mixture.

The tubular loop reactor may be designed for high-velocity movement of reaction mixtures (for example, the mixture comprising isobutylene and polymerization catalyst). The high-velocity movement may provide one or more advantages, for example, enhanced heat transfer/removal and efficient catalyst dispersion. The high velocity (e.g., a velocity in a range from about 5 m/s to about 30 m/s) of the mixture comprising isobutylene and polymerization catalyst may help ensure that heat generated during the exothermic polymerization reaction may be quickly dissipated, preventing localized hot spots and enabling the reaction to proceed under a controlled temperature, e.g., a temperature in a range from about −10° C. to about 40° C. The tubular design may also help ensure uniform polymerization catalyst distribution, enhancing the contact between isobutylene and the polymerization catalyst, which is useful for maintaining high polymerization efficiency and product uniformity. The heat transfer/removal and catalyst dispersion may help facilitate control (or precise control) of molecular weight distribution and/or may help facilitate high selectivity for terminal double bonds in the PIB product.

Tubular loop reactors useful with embodiments described herein may employ an optional reactor circulation loop 16 independent of a feed flow of an isobutylene-containing feed to the polymerization reactor (e.g., the isobutylene-containing feed in line 10) such that a velocity of the mixture comprising isobutylene and polymerization catalyst in the tubular loop reactor may be about 3 ft/sec (about 0.9 m/sec) or more, such as in a range from about 6 ft/sec (about 1.8 m/sec) to about 10 ft/sec (up to about 3.05 m/s). Such velocities facilitate turbulent flow.

Tubular loop reactors useful with embodiments described herein may employ an optional reactor circulation loop, such as those described in U.S. Patent Application Publication No. 2024/0425624, which is incorporated in its entirety to the extent consistent with embodiments of the present disclosure.

The optional reactor circulation loop 16 (where the mixture comprising isobutylene and polymerization catalyst is present) may be independent of the feed flow as they are controlled by different pumps. The circulation loop where the mixture comprising isobutylene and polymerization catalyst is present may be controlled by the in-line circulation pump 102 and the feed flow may be controlled by pump 101. Pump 101 controls flow of the isobutylene-containing feed into line 10 and into the polymerization reactor 115.

When the optional reactor circulation loop 16 is utilized, a ratio of the circulation flow of the mixture comprising isobutylene and polymerization catalyst in the optional reactor circulation loop 16 to the feed flow of the isobutylene-containing feed in line 10 may be about 10:1 or more, such as from about 10:1 to about 50:1. Such ratios facilitate turbulent flow.

In at least one embodiment, which may be combined with other embodiments, the polymerization occurs in a high-speed reactor, such as a fast reactor. As an example, the polymerization operation may be performed by the following procedure. High purity isobutylene may be fed to a tubular loop reactor and mixed in situ with a polymerization catalyst described herein such that the polymerization catalyst concentration may be in a range of from about 1,000 ppm to about 10,000 ppm, such as from about 2,000 ppm to about 10,000 ppm based on the total weight of the polymerization reaction mixture (the mixture comprising the isobutylene and polymerization catalyst). The residence time in the polymerization reactor 115 may be less than about 4 minutes. The reaction product mixture comprising HR-PIB may then be purified as described herein.

The polymerization reaction in polymerization reactor 115 converts at least a portion of isobutylene in an isobutylene-containing feed that enters the polymerization reactor 115 to a reaction product mixture comprising PIB (for example, HR-PIB). The percent conversion to PIB (or HR-PIB) may be about 50% or more, such as in a range from about 75% to about 100%, such as from about 85% to about 95%. Additionally, or alternatively, the percent conversion to PIB (or HR-PIB) may be about 90% or more, such as about 91% or more, such as about 92% or more, such as about 93% or more, such as about 94% or more, such as about 95% or more, such as about 96% or more, such as about 97% or more, such as about 98% or more, such as about 99% or more, such as about 100% based on an amount of isobutylene entering the polymerization reactor 115.

The polymerization process that occurs in polymerization reactor 115 polymerizes isobutylene to produce a polymer composition, such as PIB, for example, HR-PIB. The PIB may have any suitable number average molecular weight (Mn). For example, the PIB may have an Mn of about 180 Daltons (Da) or more, such as about 240 Da or more, such as about 300 Da or more, such as about 360 Da or more, such as about 420 Da or more, such as about 480 Da or more, such as in a range from about 180 Da to about 480 Da. Additionally, or alternatively, the PIB may have an Mn in a range from about 320 Da to about 10,000 Da, such as from about 320 Da to about 5,000 Da, such as from about 350 Da to about 5,000 Da, such as from about 700 Da to about 2,250 Da, or from about 350 Da to about 2,250, such as from about 700 Da to about 950 Da, or from about 1300 Da to about 2,250 Da.

The PIB may have any suitable polydispersity index (PDI). PDI is the ratio of Mw to Mn. The PDI (Mw/Mn) of the PIB may be about 5 or less, such as about 2.5 or less, about 2 or less, about 1.5 or less, or about 1.3 or less.

The polymer composition (for example, PIB) may include a first portion comprising polymer chains having alpha vinylidene groups (alpha vinylidene olefin isomers), a second portion comprising polymer chains having beta vinylidene groups (beta vinylidene olefin isomers), and a third portion comprising polymer chains having internal vinylidene groups (internal vinylidene olefin isomers).

The polymer composition may be an HR-PIB. HR-PIB is a PIB where:
(a) the first portion comprising polymer chains having alpha vinylidene groups may be 75 wt % or more, such as about 80 wt % or more, such as about 82 wt % or more, such as about 85 wt % or more, such as about 87 wt % or more, such as about 90 wt % or more, such as about 92 wt % or more, such as about 94 wt % or more, such as about 95 wt % or more based on a total wt % of the PIB, the total wt % of the PIB equal to 100 wt %; and
(b) a total of the second portion comprising polymer chains having beta vinylidene groups plus the third portion comprising polymer chains having internal vinylidene group may be 25 wt % or less, such as about 20 wt % or less, such as about 18 wt % or less, such as about 15 wt % or less, such as about 13 wt % or less, such as about 10 wt % or less, such as about 8 wt % or less, such as about 6 wt % or less, such as about 5 wt % or less based on the total wt % of the PIB.

Alternatively, the polymer composition may be a mid-range vinylidene PIB. Mid-range vinylidene PIBs have an alpha vinylidene content less than 75 wt %, such as about 65% or less based on the total wt % of the PIB. In these and other embodiments, the mid-range vinylidene PIB may include: a first portion comprising polymer chains having alpha vinylidene groups, a second portion comprising polymer chains having beta vinylidene groups, and a third portion comprising polymer chains having internal vinylidene groups, wherein: the first portion may be less than 75 wt %, such as from greater than 10 wt % to less than 75 wt %, such as from 40 wt % to less than 75 wt % such as from about 50 wt % to about 65 wt % based on the total wt % of the PIB; and the second portion plus the third portion may be from greater than about 25 wt % to about 60 wt % or less, such as from about 35 wt % to about 50 wt % based on the total wt % of the PIB.

The reaction product mixture comprising PIB (for example, HR-PIB) may exit the polymerization reactor 115 through line 13 and may flow into a sorber 130. The sorber 130 is configured to facilitate sorption of the polymerization catalyst onto a solid substrate. The temperature inside the sorber 130 may be controlled by coolant flow supplied by external cooling unit 135. The reaction product mixture may be recirculated in an optional sorption loop 23, for example, to provide high velocity, with use of an optional in-line circulation pump 131. The residence time in the sorber 130 may be determined by the reaction product mixture feed rate, which is independent of the circulation rate provided by the optional in-line circulation pump 131.

Solid substrate unit 120 may hold solid substrate capable of sorbing polymerization catalyst. The solid substrate may be injected into the sorber 130 via line 14 using an optional substrate metering unit 132. The solid substrate sorbs polymerization catalyst from the reaction product mixture.

Additionally, or alternatively, the solid substrate may be fed directly to the sorber 130. The solid substrate may be in the form of a slurry. For example, the solid substrate may be slurried with one or more effluents exiting from a unit shown in FIG. 1 such as oligomer coproducts and/or light polymers from PIB polymerization itself, at about 5-15 wt %, such as about 10 wt % solid substrates. Additionally, or alternatively, the solid substrate may be slurried with a non-polar carrier diluent such as alkanes from hexane through hexadecane and higher alkanes, or other carrier agents, to facilitate feeding of the solid substrate to the sorber 130.

The sorber 130 may include one or more sorbers to facilitate sorption of the catalyst by the solid substrate. For example, a tubular loop sorber may be utilized. The tubular loop sorber may be designed to operate with a high velocity circulation system, ensuring that the reaction product mixture may be continually recirculated and exposed to the solid substrate. The sorber may be capable of removing the polymerization catalyst (e.g., BF₃ catalyst complex) reaction product mixture in about 4 minutes or less, reducing the risk of unwanted side reactions that may occur with prolonged catalyst exposure (though longer times for removal are contemplated). The rapid sorption of the polymerization catalyst (e.g., BF₃ catalyst complex) onto the solid substrate may help ensure that the polymerization catalyst is removed from the reaction product mixture before the reaction product mixture reaches the solid-liquid separation step, resulting in a final filtrate with residual halogen content (for example, fluorine (F) content) of a targeted amount, e.g., less than 1,000 ppm, such as less than about 100 ppm, such as less than about 50 ppm, such as less than about 10 ppm. This significantly reduces the need for downstream purification processes and minimizes environmental impact relative to conventional technologies. Halogen content is calculated based on the amount of halogen-containing species present in the HR-PIB containing filtrate after removing the solid substrate comprising sorbed polymerization catalyst from the reaction product mixture by the solid-liquid separation

For example, the sorber may be configured to provide a filtration-ready solid substrate output, ensuring that the solid substrate comprising the sorbed BF₃ catalyst complex may be easily separated (for example, by filtration or centrifugation) from the reaction product mixture, reducing fluorine content in the HR-PIB containing filtrate after the removal operation (e.g., operation 325) to less than 100 ppm, such as less than 50 ppm, such as less than 10 ppm.

The tubular loop sorber may include one or more sorber tubes. For example, the tubular loop sorber may include a series of sorber tubes arranged in a loop configuration. The tubular loop sorber may be scalable, with the ability to adjust tube lengths, circulation rates, and cooling capacities to accommodate higher production volumes without sacrificing efficiency or PIB product quality.

The tubular loop sorber may include one or more optional in-line circulation pumps (for example, the optional in-line circulation pump 131) that maintain a high flow rate of the reaction product mixture, recirculating the reaction product mixture through the sorber tubes. The tubular loop sorber may be configured to provide high velocity flow of the reaction product mixture, the solid substrate, or both. This helps facilitate thorough mixing of the reaction product mixture and the solid substrate. The tubular loop sorber may be operated to provide sufficient residence time of the reaction product mixture and the solid substrate within the tubular loop sorber. This may facilitate rapid and/or partial (or complete) sorption of the polymerization catalyst from the reaction product mixture and onto the solid substrate.

Polymerization catalyst removal processes of the present disclosure are significantly advantaged over conventional technologies. For example, the amount of solid substrate used for embodiments described herein may be orders of magnitude less than conventionally required. Further, embodiments described herein may utilize any suitable sorption time. The sorption time refers to a residence time of the reaction product mixture in the sorber. Typically, the sorption time is longer than the physical time it takes for the substrate to sorb the catalyst. Sorption may be quick and without significant exotherm.

In some embodiments, which may be combined with other embodiments, the sorption time may be in a range from about 30 seconds to about 120 minutes, such as from about 1 minute to about 110 minutes, such as from about 2 minutes to about 110 minutes, such as from about 3 minutes to about 100 minutes, such as from about 4 minutes to about 100 minutes, such as from about 5 minutes to about 90 minutes, such as from about 10 minutes to about 80 minutes, such as from about 20 minutes to about 70 minutes, such as from about 30 minutes to about 60 minutes. Additionally or alternatively, the sorption time may be about 90 minutes or less, such as about 80 minutes or less, such as about 70 minutes or less, such as about 60 minutes or less, such as about 50 minutes or less, such as about 40 minutes or less, such as about 30 minutes or less, such as about 20 minutes or less, such as about 10 minutes or less, such as about 5 minutes or less, such as about 4 minutes or less, or less than 4 minutes.

The tubular loop sorber may be operated with a circulation rate to feed flow rate ratio in a range from about 1:1 to about 150:1, such as from about 10:1 to about 100:1, such as from about 20:1 to about 75:1. This circulation rate to feed flow rate may help ensure adequate turbulence for solid substrate dispersion and rapid polymerization catalyst sorption within 4 minutes or less.

The tubular loop sorber may include a multi-pass tube-in-shell heat exchanger. The multi-pass tube-in-shell heat exchanger helps maintain temperature control during sorption of the polymerization catalyst by the solid substrate. Here, the reaction product mixture may flow through one or more tubes of the tubular loop sorber and a cooling medium (supplied from, for example, external cooling unit 135) may be circulated through shells of the tubular loop sorber to maintain temperature control. Such a configuration may be utilized to prevent or at least mitigate thermal degradation of the polymerization catalyst (for example, liquid BF₃ catalyst complex) during sorption onto the solid substrate.

The sorber 130, for example, tubular loop sorber, may include one or more solid substrate injection points. The one or more solid substrate injection points may be configured to directly inject the solid substrate into the reaction product mixture while the reaction product mixture is in the sorber. It is noted that the polymerization reaction may still be occurring while the reaction product mixture is in the sorber 130. Accordingly, the solid substrate may be injected into the reaction product mixture during and/or after the isobutylene polymerization reaction.

The sorber 130 may be configured for batch operation or continuous operation. Such operation may facilitate the maintaining of constant contact between the reaction product mixture and the solid substrate, and may help ensure efficient sorption and removal of the polymerization catalyst from the reaction product mixture.

The reaction product mixture comprising the sorbed polymerization catalyst and the PIB may exit the sorber 130 via line 15 and may flow into a solid-liquid separation unit 140, for example, a catalyst removal unit. The solid-liquid separation unit may be configured to separate or remove the solid substrate comprising the sorbed polymerization catalyst from the reaction product mixture. The solid-liquid separation unit may be further configured to discharge an HR-PIB containing filtrate.

At the solid-liquid separation unit 140, the solid substrate comprising the sorbed polymerization catalyst may be separated from the reaction product mixture containing the PIB. The solid-liquid separation unit 140 may include any suitable solid-liquid separation apparatus, such as an apparatus for performing filtration, vacuum filtration, centrifugation, decanting, decanting centrifugation, or combinations thereof. The solid substrate comprising the sorbed polymerization catalyst may be recovered from the solid-liquid separation unit 140 via line 17.

Overall, the various techniques for polymerization catalyst sorption may facilitate enhanced sorption of the polymerization catalyst relative to conventional technologies and complete (or nearly complete) removal of the polymerization catalyst from the reaction product mixture without using conventional water washing and solvent extraction operations. For example, the processing plant may be free of a dehalogenating unit (such as a defluorinating unit and a dechlorinating unit) that serves to separate or remove halogen-containing species such as HF, HCl, organic fluorides, organic chlorides, combinations thereof, or other halogen-containing species from the reaction product mixture.

The removal or separation of the solid substrate comprising sorbed polymerization catalyst from the reaction product mixture in the solid-liquid separation unit 140 results in a PIB-containing filtrate (also called a catalyst-depleted effluent comprising the PIB). The PIB-containing filtrate may be an HR-PIB containing filtrate (also called a catalyst-depleted effluent comprising the HR-PIB). As used herein, an effluent that is “depleted” in, for example, catalyst, refers to an effluent where the relative amount (or concentration) of polymerization catalyst in an effluent after a process operation (for example, after a solids separation process) is less than the relative amount (or concentration) of polymerization catalyst in the effluent before the process operation. For example, if an effluent includes 0.1 wt % polymerization catalyst before a solids separation process, the effluent formed after the solids separation process would include less than 0.1 wt % polymerization catalyst. The solid catalyst-depleted effluent may include minor amounts of solid substrate comprising sorbed polymerization catalyst, for example, less than 100 ppm. The solids separation process is further described herein with respect to operation 325.

The HR-PIB containing filtrate (the catalyst-depleted effluent) may exit the solid-liquid separation unit 140 via line 18. This HR-PIB containing filtrate may still be crude at this stage, containing coproducts, unreacted materials, and/or impurities. The HR-PIB containing filtrate flowing through line 18 may be introduced to one or more separation units (such as distillation columns) that purify the HR-PIB and strip coproducts, unreacted materials, and/or impurities from the solid catalyst-depleted effluent in order to form a high purity HR-PIB effluent exiting the processing plant 100 via line 21. These one or more units that purify the HR-PIB may include a C4 separation unit 160, an oligomer separation unit 170, or combinations thereof. These one or more units that purify the HR-PIB are optional depending on the purity levels desired for the HR-PIB. For example, the HR-PIB containing filtrate may be introduced into the C4 separation unit 160 only. Alternatively, the HR-PIB containing filtrate may be introduced into the oligomer separation unit 170 only. That is, the HR-PIB containing filtrate may bypass one or more of the C4 separation unit 160 and the oligomer separation unit 170, or be processed in one or more of the C4 separation unit 160 and the oligomer separation unit 170.

The HR-PIB containing filtrate may optionally include additional components such as diluent (e.g., isobutane, hexane, or combinations thereof), unreacted isobutylene, isobutylene oligomer coproducts, or combinations thereof. The HR-PIB containing filtrate and optional additional components may then be introduced to the C4 separation unit 160. The C4 separation unit 160 serves to remove or otherwise separate the one or more optional additional components present in the HR-PIB containing filtrate from the HR-PIB. For example, the C4 separation unit 160 may be configured to remove unreacted isobutylene from the HR-PIB containing filtrate. The C4 separation unit 160 may be further configured to remove diluent (e.g., isobutane, hexane, or combinations thereof) from the HR-PIB containing filtrate. The C4 separation unit 160 may be further configured to produce a C4-separated effluent.

The C4 separation unit 160 may include any suitable apparatus for removing, for example, diluent (e.g., isobutane, hexane, or combinations thereof), unreacted isobutylene, or combinations thereof from the HR-PIB containing filtrate. Suitable apparatus for the C4 separation unit 160 may include a debutanizer column, a debutanizer fractionator, a distillation column, a fractional distillation column, a stripping column, or combinations thereof.

The C4 separation unit 160 may be operated under any suitable conditions effective to separate or remove the one or more optional additional components from the HR-PIB containing filtrate. For example, the C4 separation operation in the C4 separation unit 160 may be performed with the following example conditions. The HR-PIB containing filtrate may be passed through a distillation column operating at weight hourly space velocity WHSV that may be from about 1 h 1 to about 60 h 1 (or more), at a column temperature that may be in a range from about 25° C. to about 100° C., and a column pressure that may be in a range from about 25 psi (about 172 kPa) to about 100 psi (about 689 kPa).

Diluent (e.g., isobutane, hexane, or combinations thereof), unreacted isobutylene, or combinations thereof (if any) may exit the C4 separation unit 160 (e.g., leaving overhead) through line 19 where the diluent, unreacted isobutylene, or combinations thereof may then be combined with the isobutylene-containing feed in line 10. Additionally, or alternatively, the diluent, unreacted isobutylene, or combinations thereof may be introduced to the solid substrate unit 120 where it may be used to form a slurry with the solid substrate.

The C4-separated effluent may exit the C4 separation unit 160 through line 20 as a “bottoms” stream. After the C4 separation in the C4 separation unit 160, an amount of HR-PIB in the C4-separated effluent may be about 50 wt % or more, about 70 wt % or more, about 85 wt % or more, about 90 wt % or more, about 91 wt % or more, such as about 92 wt % or more, such as about 93 wt % or more, such as about 94 wt % or more, such as about 95 wt % or more, such as about 96 wt % or more, such as about 97 wt % or more, such as about 98 wt % or more, such as about 99 wt % or more, such as about 100 wt % based on a total wt % of the C4-separated effluent exiting the C4 separation unit 160 through line 20.

The C4-separated effluent comprising the HR-PIB flowing through line 20 may optionally include one or more additional components such as isobutylene oligomer coproducts (e.g., C20 or lower isobutylene oligomer coproducts, such as C8-C20 isobutylene oligomer coproducts, such as C12-C16 isobutylene oligomer coproducts), diluent (e.g., isobutane, hexane, or combinations thereof), or combinations thereof. The C4-separated effluent comprising the HR-PIB and optional additional components may then be introduced to the oligomer separation unit 170. The oligomer separation unit 170 serves to remove or otherwise separate the one or more optional additional components present in the C4-separated effluent from the HR-PIB. For example, the oligomer separation unit 170 may be configured to remove isobutylene oligomer coproducts, diluent (e.g., isobutane, hexane, or combinations thereof), or combinations thereof. The oligomer separation unit 170 may include any suitable apparatus for removing, for example, isobutylene oligomer coproducts from the C4-separated effluent. Suitable apparatus for the oligomer separation unit 170 may include a distillation column, a fractional distillation column, a stripping column, or combinations thereof.

The oligomer separation unit 170 may be operated under any suitable conditions effective to separate or remove the one or more optional components, e.g., isobutylene oligomers, from the C4-separated effluent. Suitable conditions for operating the oligomer separation unit 170 may include passing the C4-separated effluent through a distillation column operating at a temperature that may be in a range from about 150° C. to about 275° C. and a pressure that may be in a range from about 1 millimeter of mercury (mmHg) to about 100 mmHg, such as from about 10 mmHg to about 50 mmHg.

The oligomer separated effluent comprising the HR-PIB (“bottoms” stream) may exit the oligomer separation unit 170 through line 21. The oligomer separated effluent may be a highly pure (e.g., >95% pure, such as about 98% or more, such as about 99% or more, such as 100%) PIB composition or HR-PIB composition based on a total wt % of the oligomer separated effluent.

The isobutylene oligomer coproducts, diluent, or combinations thereof (if any) may exit the oligomer separation unit 170 (leaving “overhead”) through line 22 where the isobutylene oligomer coproducts, diluent, or combinations thereof (if any) may be introduced into the cracking unit 180. Additionally, or alternatively, the isobutylene oligomer coproducts, polymerization catalyst diluent, or combinations thereof (if any) may be introduced to the solid substrate unit 120 where it may be used to form a slurry with the solid substrate.

At the cracking unit 180, isobutylene oligomer coproducts may be converted to isobutylene. The cracking unit 180 may be configured to crack isobutylene oligomer coproducts into isobutylene. The cracking unit 180 breaks down, or cracks, the isobutylene oligomers into a cracking product effluent comprising isobutylene. The cracking product effluent exiting the cracking unit 180 via line 11 may include a high purity isobutylene, for example, a HR-PIB grade isobutylene.

The cracking of the isobutylene oligomers in the cracking unit 180 may be performed under any suitable conditions effective to crack at least a portion of the isobutylene oligomers present in the oligomerization product effluent. Suitable catalysts for the cracking operation may include metal oxides, such as gamma-alumina; activated metal oxides, such as solid BF₃ metal oxide complexes; zeolites, such as Y-zeolites; activated zeolites; or combinations thereof. As an example, the cracking may be performed by the following non-limiting procedure. A stream containing isobutylene oligomer coproducts, such as dimers, trimers, tetramers, pentamers, or combinations thereof, may be passed over a magnesium silicate catalyst contained in a suitable fixed bed reactor. The cracking reactor conditions may include a temperature that may be in a range from about 250° C. to about 450° C., a pressure that may be about atmospheric pressure, and a LHSV that may be in a range from about 1 h⁻¹ to about 5 h⁻¹. The stream containing isobutylene oligomers may be diluted with an inert gas such as nitrogen to a volume percent in a range from about 10 vol % to about 90 vol %.

The cracking operation converts at least a portion of isobutylene oligomers in the oligomerization product effluent that enters the cracking unit 180 to the cracking product effluent. The percent conversion may be about 50% or more, such as in a range from about 75% to about 100%, such as from about 85% to about 95%, or greater than about 90%, such as about 91%, such as about 92%, such as about 93%, such as about 94%, such as about 95%, such as about 96%, such as about 97%, such as about 98%, such as about 99%, such as about 100% based on an amount of isobutylene oligomers entering the cracking unit 180 through line 22.

The cracking product effluent comprising the isobutylene exiting the cracking unit 180 via line 11 may then be combined with the isobutylene-containing feed in line 10. Additionally, or alternatively, the isobutylene exiting the cracking unit 180 may be introduced directly to the polymerization reactor 115 (e.g., PIB reactor). The cracking product effluent and the isobutylene-containing feed may both contain isobutylene.

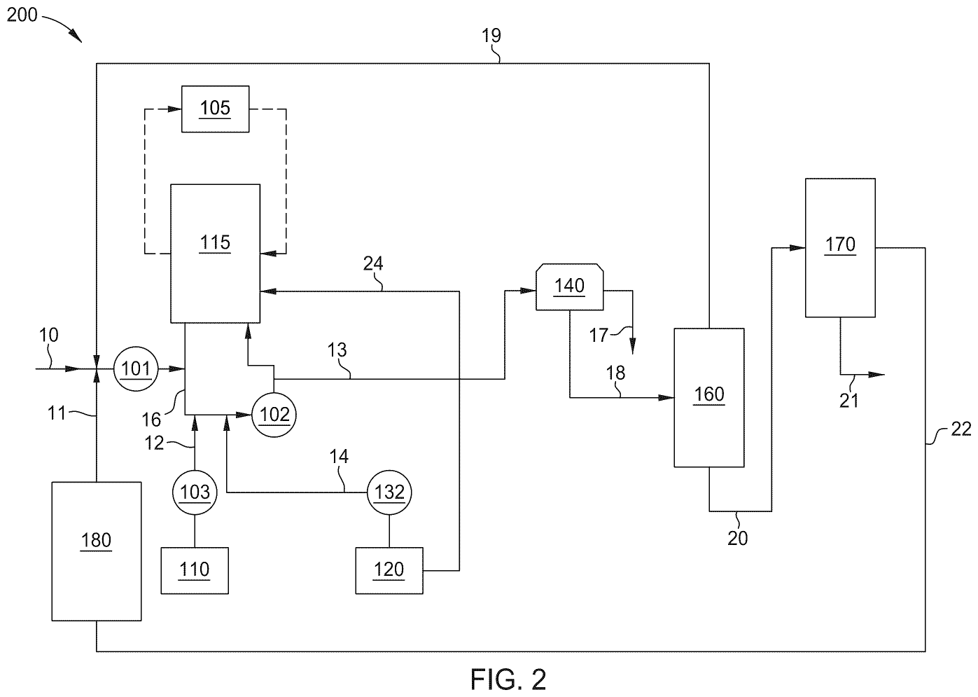

FIG. 2 is a generalized schematic flow diagram of a processing plant 200 for implementing various processes described herein to produce PIB (for example, HR-PIB). As shown in FIG. 2, the processing plant 200 is free of the sorber 130. Instead, the solid substrate unit 120 may be coupled to the polymerization reactor 115 via the optional reactor circulation loop 16 or may be coupled directly to the polymerization reactor 115 via line 24. The reaction product mixture comprising PIB (for example, HR-PIB) and the sorbed polymerization catalyst may exit the polymerization reactor 115 through line 13 and may flow into the solid-liquid separation unit 140, where the solid substrate comprising the sorbed polymerization catalyst may be separated from the reaction product mixture comprising the PIB. Other portions of processing plant 200 are described herein with respect to processing plant 100 shown in FIG. 1.

With respect to processing plants described herein, for example, processing plant 100 and processing plant 200, the lines may be coupled to inlets and outlets of the reactors, units, or other lines to allow various streams or feeds to flow through the various reactors, units, and lines of the processing plant 100 and processing plant 200. For example, in processing plant 100, the solid-liquid separation unit 140 may include a first outlet coupled to line 18 and the C4 separation unit 160 may have a first inlet coupled to line 18. This allows the HR-PIB containing filtrate to exit the solid-liquid separation unit 140 through the first outlet of the solid-liquid separation unit 140, flow to the C4 separation unit 160 through line 18, and enter the C4 separation unit 160 through the inlet of the C4 separation unit 160.

Although not shown in FIG. 1 and FIG. 2, it should be understood that suitable equipment for controlling, for example, temperature, pressure, and flow control of various feeds, effluents, and output streams may be used with the processing plant 100 and the processing plant 200. For example, heat exchangers may be used to cool or heat a liquid or a gas along one or more lines or within various units or reactors of the processing plant 100 and processing plant 200. Pumps and motors may be utilized to control the rate of flow of the materials traveling or flowing through the lines and the operating pressures of various components of the processing plant 100 and the processing plant 200. Further, the processing plant 100 and the processing plant 200 may include valves or other release mechanisms for, e.g., purging gases or liquids from the system. Various process controls may be used. Such process controls may include probes and sensors such as pressure indicators, differential pressure cells, temperature indicators, thermocouples, temperature switches, resistance temperature detectors, solenoids, flowmeters, flow regulators and valves, gas analyzers, humidity sensors, radar sensors, ammeters, current meters, liquid level detectors, feed level probes, electrical drives, and combinations thereof.

Optionally one or more elements described with respect to the processing plant 100 and processing plant 200 may be coupled to a controller. The controller may be utilized to control, for example, one or more operating parameters of the one or more elements illustrated in the processing plant 100 and processing plant 200, one or more operations of processes described herein (for example, one or more operations of process 300), or combinations thereof. The controller may include a processor, memory, and support circuits. The processor may be one of any form of general purpose microprocessor, or a general purpose central processing unit (CPU), each of which may be used in an industrial setting, such as a programmable logic controller (PLC), supervisory control and data acquisition (SCADA) systems, or other suitable industrial controller.

The memory is non-transitory and may be one or more of readily available memory such as random access memory (RAM), read only memory (ROM), or any other form of digital storage, local or remote. The memory contains instructions, that when executed by the processor, may facilitate the operation of one or more elements illustrated in processing plant 100 and processing plant 200, one or more operations of process 300, or combinations thereof. The instructions in the memory are in the form of a program product such as a program that implements the method of the present disclosure. The program code of the program product may conform to any one of a number of different programming languages. Illustrative computer-readable storage media include, but are not limited to: (i) non-writable storage media (for example, read-only memory devices within a computer such as CD-ROM disks readable by a CD-ROM drive, flash memory, ROM chips, or any type of solid-state non-volatile semiconductor memory) on which information is permanently stored; and (ii) writable storage media (for example, floppy disks within a diskette drive or hard-disk drive or any type of solid-state random-access semiconductor memory) on which alterable information is stored. Such computer-readable storage media, when carrying computer-readable instructions that direct the functions of the methods described herein, are examples of the present disclosure. The disclosure may be, for example, implemented as the program product stored on a computer-readable storage media (for example, memory) for use with a computer system (not shown). The program(s) of the program product define functions of the disclosure, described herein. The controller may be configured to cause the polymerization reactor: to receive a feed comprising isobutylene; to receive a feed comprising the polymerization catalyst; to react a mixture comprising isobutylene and polymerization catalyst to form the reaction product mixture comprising the HR-PIB; to discharge the reaction product mixture comprising the HR-PIB; or combinations thereof.

### Processes

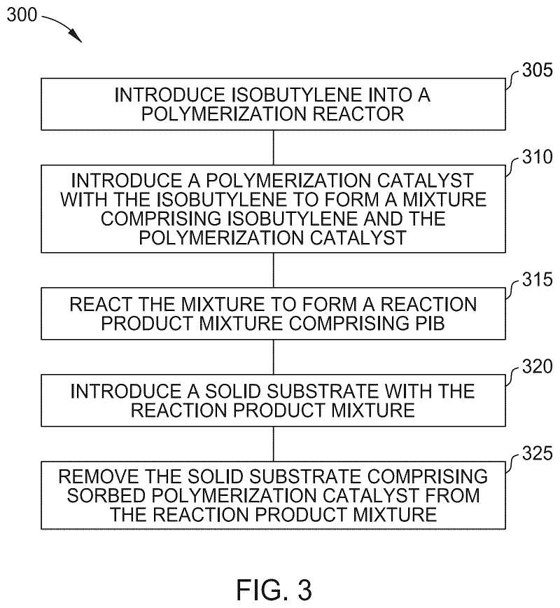

Embodiments of the present disclosure also generally relate to processes for producing PIB, for example, HR-PIB. FIG. 3 shows selected operations of a process 300 for producing PIB, for example, HR-PIB according to at least one embodiment of the present disclosure. The process 300 may include a continuous process or a batch process for forming the PIB. Although processes of the present disclosure may be described with respect to producing HR-PIB, the processes may be utilized for producing PIB unless the context clearly indicates otherwise.

The process 300 may begin with introducing isobutylene into a polymerization reactor at operation 305. At operation 305, isobutylene-containing feed may be fed to polymerization reactor 115 via line 10. Additionally, or alternatively, the isobutylene may be fed to the optional reactor circulation loop 16. The isobutylene may be part of an isobutylene-containing stream that includes optional components such as any suitable non-polar hydrocarbon diluent such as isobutane, hexane, or combinations thereof. Additionally, or alternatively, the isobutylene-containing feed may be a high-purity isobutylene feed such as a high-purity isobutylene feed obtained by cracking isobutylene oligomers. For example, the high-purity isobutylene feed may be made using cracking unit 180 which is coupled to the polymerization reactor 115 via line 11.

The process 300 may further include introducing a polymerization catalyst with the isobutylene to form a mixture comprising the isobutylene and the polymerization catalyst at operation 310. As described herein, the polymerization catalyst introduced may be in the form of, for example, a liquid, a solid, a gas, or combinations thereof. For example, the polymerization catalyst may be injected or otherwise introduced into the polymerization reactor 115 via line 12 using the optional catalyst feed pump 103. Additionally, or alternatively, the polymerization catalyst may be fed directly to the polymerization reactor of the polymerization reactor 115. Additionally, or alternatively, the polymerization catalyst may be added to a feed comprising isobutylene prior to entering the polymerization reactor.

The polymerization catalyst facilitates or promotes polymerization of the isobutylene present in the mixture. The polymerization catalyst may include any suitable Lewis acid catalyst, Lewis acid catalyst complex, or combinations thereof. A “catalyst complex” refers to a complex of a catalyst and a complexing agent. For example, a Lewis acid catalyst complex includes a Lewis acid catalyst and a complexing agent.

The polymerization catalyst may be a liquid, a gas, a solid (such as powders), or combinations thereof. Suitable Lewis acid catalysts useful as a polymerization catalyst may include a fluorine-containing material, a chlorine-containing material, or combinations thereof. Suitable fluorine-containing materials may include BF₃, tris(pentaflurophenyl)borane (C₆F₅)₃B, or a combination thereof. Suitable chlorine-containing materials may include a metal chloride (for example, AlCl₃, ZnCl₂, SnCl₄, TiCl₄), a metal alkyl chloride (for example, ethylaluminum dichloride (EtAlCl₂)), or combinations thereof.

Suitable Lewis acid catalyst complexes include a Lewis acid and a complexing. The Lewis acid catalyst may include one or more of those described herein. The complexing agent may include an oxygen-containing compound (also referred to as an oxygenate).

Oxygen-containing compounds may include an alcohol, an ether, a ketone, an aldehyde, a carboxylic acid, or combinations thereof. The complexing agent may include a C1 to C10 unsubstituted alcohol, a C1 to C10 substituted alcohol, a C2 to C20 unsubstituted ether, or a C2 to C20 substituted ether. The complexing agent may include more than one oxygen containing group per molecule, for example, glycols (substituted or unsubstituted) and polyols (substituted or unsubstituted), for example wherein each hydroxyl is in a primary position, or for example, a C1 to C10 glycol (substituted or unsubstituted) such as ethylene glycol, 1,4-butanediol, trimethylolethane (2-(hydroxymethyl)-2-methylpropane-1,3-diol; C₅H₁₂O₃), trimethylolpropane (2-(hydroxymethyl)-2-ethylpropane-1,3-diol; C₆H₁₄O₃), pentaerythritol (2,2-bis(hydroxymethyl)propane-1,3-diol; C₅H₁₂O₄), or tris(hydroxymethyl)aminomethane (C₄H₁₁NO₃).

Oxygen-containing compounds may include methanol (MeOH), ethanol, isopropanol, n-propanol, neopentyl alcohol, dimethyl ether, diethyl ether, diisopropyl ether, diisobutyl ether, di-tert-butyl ether, methyl tert-butyl ether, ethylene glycol, neopentyl alcohol, 2,2-dimethylbutanol, 2,2-dimethylpentanol, 2,2-dimethylhexanol, benzyl alcohol, a ring-substituted benzyl alcohol, or combinations thereof. The complexing agent may include an alcohol that lacks (or is free of) beta-hydrogen atoms. Alcohols with a beta hydrogen atom may undergo an undesired dehydration/beta-elimination reactions. Accordingly, use of oxygen-containing compounds that are free of beta-hydrogen atoms prevent, or at least mitigate, beta-elimination reactions during polymerization of the isobutylene. Oxygen-containing compounds that lack beta hydrogen atoms may include methanol, a 2,2-dimethyl alcohol (for example, neopentyl alcohol, 2,2-dimethylbutanol, 2,2-dimethylpentanol, and 2,2-dimethylhexanol), benzyl alcohol, a ring-substituted benzyl alcohol, or combinations thereof.

A catalyst complex may be formed by adding a Lewis acid catalyst to an oxygen-containing compound. For example, a catalyst complex comprising BF₃/complexing agent (such as BF₃·MeOH) may be formed by passing BF₃ gas through a pure anhydrous oxygen-containing compound at a rate that allows the BF₃ to be efficiently contacted by the oxygen-containing compound. An illustrative, but non-limiting, example of a Lewis acid catalyst complex may include BF₃·MeOH.

A catalyst complex comprising a Lewis acid catalyst/complexing agent (for example, BF₃/complexing agent) may include any suitable molar ratio of complexing agent to Lewis acid catalyst. For example, a catalyst complex may include a molar ratio of complexing agent to Lewis acid catalyst that may be in a range from about 0.1 to about 10, such as from about 0.2 to about 5, such as from about 0.2 and 2, such as from about 0.5 to about 2, such as from about 1.0 to about 1.9, such as from about 1.0 to about 1.3, for example, about 1.0, or from about 1.3 to about 1.5, such as about 1.4.

The process 300 may further include reacting the mixture comprising the isobutylene and the polymerization catalyst at operation 315. The reaction at operation 315 is an isobutylene polymerization reaction that forms a reaction product mixture comprising PIB, such as HR-PIB. The reaction product mixture is also referred to herein as a reaction product effluent. The reaction product mixture may further include polymerization catalyst.

Operation 315 may be performed in polymerization reactor 115. The reaction at operation 315 may be performed under polymerization conditions effective to form PIB. Illustrative, but non-limiting, polymerization conditions effective to form PIB, such as HR-PIB, are described herein. Polymerizations conditions utilized at operation 315 may include maintaining isothermal conditions within the polymerization reactor 115 to control a molecular weight of the HR-PIB. Additionally, or alternatively, polymerizations conditions utilized at operation 315 may include allowing for a predetermined isobutylene residence time in the polymerization reactor 115 to convert isobutylene to HR-PIB.

The process 300 may further include introducing a solid substrate with the crude reaction product mixture comprising PIB at operation 320. For example, operation 320 may include sorbing the polymerization catalyst onto the catalyst substrate. As described herein, the reaction product mixture further includes polymerization catalyst.

The solid substrate is capable of sorbing the polymerization catalyst any suitable amount of polymerization catalyst sorption capacity. For example, the solid substrate may have the capacity to sorb an amount of the BF₃ catalyst complex such that the resultant solid substrate comprising sorbed polymerization catalyst has a concentration of the polymerization catalyst (calculated as wt % of Lewis acid catalyst (e.g., wt % of BF₃)) that is about 1 wt % or more, such as about 5 wt % or more, such as about 10 wt % or more, such as about 15 wt % or more, such as about 20 wt % or more, such as about 25 wt % or more, such as about 30 wt % or more, such as about 35 wt % or more, such as about 40 wt % or more, such as about 45 wt % or more, such as about 50 wt % or more, such as about 55 wt % or more, such as about 60 wt % or more, such as about 65 wt % or more, such as about 70 wt % or more, such as about 75 wt % or more, such as about 80 wt % or more, such as about 85 wt % or more, such as about 90 wt % or more, such as about 95 wt % or more based on a total wt % of the resultant solid substrate with polymerization catalyst sorbed (with a maximum of 100 wt %). Any of the foregoing numbers may be used singly to describe an open-ended range or in combination to describe a close-ended range. The total wt % of the solid substrate comprising sorbed polymerization catalyst equal to 100 wt %.

The amount of polymerization catalyst sorbed is calculated based on the Lewis acid catalyst sorbed and not including the oxygenated compound of the complex (regardless of whether the polymerization catalyst comprises the Lewis acid catalyst or the Lewis acid catalyst complex). For example, if a BF₃ catalyst complex (such as BF₃·MeOH) is used as the polymerization catalyst, the solid substrate is capable of sorbing an amount of the BF₃ catalyst complex such that the resultant solid substrate with BF₃ catalyst complex sorbed has a concentration of BF₃ that is about 1 wt % or more, such as about 5 wt % or more, such as about 10 wt % or more, such as about 15 wt % or more, such as about 20 wt % or more, such as about 25 wt % or more, such as about 30 wt % or more, such as about 35 wt % or more, such as about 40 wt % or more, such as about 45 wt % or more, such as about 50 wt % or more, such as about 55 wt % or more, such as about 60 wt % or more, such as about 65 wt % or more, such as about 70 wt % or more, such as about 75 wt % or more, such as about 80 wt % or more, such as about 85 wt % or more, such as about 90 wt % or more, such as about 95 wt % or more based on the total wt % of the resultant solid substrate with BF₃ catalyst complex sorbed (calculated as wt % of BF₃).

The solid substrate may be any suitable solid substrate capable of sorbing a polymerization catalyst described herein, for example, a Lewis acid catalyst and/or Lewis acid complex. The solid substrate may form a stable adduct with the polymerization catalyst. The solid substrate may be a porous solid substrate, Suitable solid substrates may include inorganic oxides, metal oxides doped with rare earth metals, rare earth metals themselves, or combinations thereof. The solid substrates may include an inorganic oxide in a finely divided form, such as a powder. Suitable solid substrates may include metal oxides of Group IIIA, Group IVA, and/or Group IVB of the periodic table of the elements, such as alumina, silica, titania, or mixtures thereof. Combinations of solid substrates may be used, for example, silica-alumina and silica-titania. Illustrative, but non-limiting, solid substrates may include, or be selected from, Al₂O₃, ZrO₂, TiO₂, SnO₂, CeO₂, SiO₂, SiO₂/Al₂O₃, or combinations thereof, such as SiO₂, Al₂O₃, SiO₂/Al₂O₃ (silica-alumina), or combinations thereof.

The solid substrate may have one or more of the following properties:

(a) The solid substrate may include an Al₂O₃ content that is greater than 0 wt %, such as greater than about 1 wt %, such as greater than about 3 wt %, such as greater than about 5 wt %, such as greater than about 10 wt %, such as greater than about 15 wt %, such as greater than about 20 wt %, such as greater than about 25 wt %, such as greater than about 30 wt %, such as greater than about 35 wt %, such as greater than about 40 wt %, such as greater than about 45 wt %, such as greater than about 50 wt % based on the total wt % of the solid substrate. The total wt % of the solid substrate is equal to 100 wt %. Additionally, or alternatively, the solid substrate may include an Al₂O₃ content that is less than 100 wt % SiO₂, such as less than about 99 wt %, such as less than about 97 wt %, such as less than about 95 wt %, such as less than about 90 wt %, such as less than about 85 wt %, such as less than about 80 wt %, such as less than about 75 wt %, such as less than about 70 wt %, such as less than about 65 wt %, such as less than about 60 wt %, such as less than about 55 wt %, such as less than about 50 wt % based on the total wt % of the solid substrate. Additionally, or alternatively, the solid substrate may include an Al₂O₃ content that is in a range from about 25 wt % to about 75 wt %, such as from about 25 wt % to about 50 wt % based on a total wt % of the solid substrate. Additionally, or alternatively, the solid substrate may include an Al₂O₃ content that is within those aforementioned weight percents.

(b) The solid substrate may include an SiO₂ content that is greater than 0 wt %, such as greater than about 1 wt %, such as greater than about 3 wt %, such as greater than about 5 wt %, such as greater than about 10 wt %, such as greater than about 15 wt %, greater than about 20 wt %, such as greater than about 25 wt %, such as greater than about 30 wt %, greater than about 35 wt %, such as greater than about 40 wt %, such as greater than about 45 wt %, such as greater than about 50 wt % based on the total wt % of the solid substrate. Additionally, or alternatively, the solid substrate may include an SiO₂ content that is less than 100 wt %, such as less than about 99 wt % SiO₂, such as less than about 97 wt %, such as less than about 95 wt %, such as less than about 90 wt %, such as less than about 85 wt %, such as less than about 80 wt %, such as less than about 75 wt %, such as less than about 70 wt %, such as less than about 65 wt %, less than about 60 wt %, such as less than about 55 wt %, such as less than about 50 wt % based on the total weight of the solid substrate. Additionally, or alternatively, the solid substrate may include an SiO₂ content that is within those aforementioned weight percents.

(c) The solid substrate may be characterized as having a surface area that is greater than about 10 m²/g, about 750 m²/g or less, or a combination thereof, such as in a range from about 10 m²/g to about 700 m²/g, such as from about 50 m²/g to about 500 m²/g, such as from about 100 m²/g to about 400 m²/g. Additionally, or alternatively, the solid substrate may be characterized as having surface area that is greater than about 150 m²/g (with a maximum that may be about 750 m²/g).

(d) The solid substrate may be characterized as having a pore volume that is greater than about 0.1 cc/g, such as in a range from about 0.1 cc/g to about 4.0 cc/g, such as from about 0.5 cc/g to about 3.5 cc/g, such as from about 0.8 cc/g and about 3.0 cc/g.

(e) The solid substrate may be characterized as having a monodispersed particle size or a distribution of particle sizes with an average particle size that is greater than about 5 μm, such as in a range from about 5 μm to about 500 μm, such as from about 5 μm to about 200 μm, such as from about 10 μm to about 100 μm.

(f) The solid substrate may be characterized as having an average pore size (diameter) that is greater than about 1 nm, such as in a range from about 1 nm to about 100 nm, such as from about 5 nm to about 75 nm, such as from about 7.5 nm and about 48 nm, or from about 20 nm to about 150 nm.

(g) The solid substrate may be characterized as having a pore volume that is greater than about 0.3 cc/g, such as in a range from about 0.3 cc/g to about 2.0 cc/g, such as from about 0.5 cc/g to about 1.75 cc/g, such as from about 0.75 cc/g to about 1.5 cc/g.

(h) The solid substrate may be characterized as having an amount of Fe₂O₃ that is less than about 5 wt %, such as less than about 1 wt %, such as less than about 0.5 wt %, such as less than about 0.2 wt %, such as 0 wt % based on the total wt % of the solid substrate.

(i) The solid substrate may be characterized as having an amount of Na₂O that is less than about 5 wt % such as less than about 1 wt %, such as less than about 0.5 wt %, such as less than about 0.2 wt %, such as less than about 0.02 wt %, such as 0 wt % based on the total wt % of the solid substrate.

The solid substrate may include, for example, a high surface area, amorphous silica (for example, a surface area in a range from about 250 m²/g to about 350 m²/g, such as about 300 m²/g, and a pore volume in a range from about 1.3 cc/g to about 2.0 cc/g, such as about 1.65 cc/g).

Illustrative, but non-limiting, examples of solid substrates may include one or more of the following: ALS 75 SiO₂/Al₂O₃ (silica-alumina) which is commercially available from Pacific Industrial Development Corporation, Ann Arbor, Michigan; gamma-alumina spheres (γ-Al₂O₃) which is commercially available from BASF); ALS 50 SiO₂/Al₂O₃ (silica-alumina) which is commercially available from Pacific Industrial Development Corporation; or combinations thereof. ALS 75 includes about 75 wt % SiO₂ and about 25 wt % Al₂O₃. ALS 50 includes about 50 wt % SiO₂ and about 50 wt % Al₂O₃.

In some embodiments, which may be combined with other embodiments, the solid substrate may comprise sorbed complexing agent prior to introducing the solid substrate with the polymerization. The solid substrate comprising sorbed complexing agent may be utilized when, for example, a gaseous Lewis acid catalyst (e.g., BF₃ gas) is utilized for polymerization.

Generally, the solid substrate may be added before, during, and/or after the polymerization reaction to form the PIB. That is, the solid substrate may combine with or contact the polymerization catalyst in the polymerization reactor 115, at a location upstream of the polymerization reactor 115, at a location downstream from the polymerization reactor 115, or combinations thereof, among other possibilities. Accordingly, operation 320 may be performed at any suitable point, or multiple points, within the process 300.

The solid substrate has high capacity for polymerization catalyst. The sorption of the polymerization catalyst by the solid substrate may be without significant exotherm.

The solid substrate may be pre-impregnated with a polymerization catalyst before the isobutylene polymerization reaction. This process may involve preparing a solid catalyst by sorbing the polymerization catalyst (for example, liquid BF₃ catalyst complex) onto the solid substrate prior to its introduction into the polymerization reactor, and then feeding the pre-formed solid catalyst into the polymerization reactor. Additionally, or alternatively, the pre-formed solid catalyst may be co-fed with the isobutylene-containing feed into the polymerization reactor 115. Overall, this may facilitate use of a polymerization catalyst that may include a pre-formed solid catalyst comprising a solid (e.g., a solid substrate) impregnated with polymerization catalyst, and allows the isobutylene polymerization reaction to proceed with the catalyst already in solid form.

The solid substrate may be introduced into the polymerization reactor where it contacts the reaction product mixture (or reaction product mixture) in the polymerization reactor 115. As shown in FIG. 2, the solid substrate may flow from the solid substrate unit 120 to the polymerization reactor 115 via line 24. The line 24 couples the solid substrate unit 120 with the polymerization reactor 115.

The solid substrate may be co-fed with the polymerization catalyst to the polymerization reactor 115 in a single stream. Although not shown in FIG. 2, the polymerization catalyst (held in polymerization catalyst unit 110) and the solid substrate (held in solid substrate unit 120) may combine at some location prior to entering the polymerization reactor 115. For example, a precontactor coupled to the polymerization reactor 115 may be utilized. The precontactor may be a vessel with a mixing device. The polymerization catalyst and the solid substrate may be fed into the precontactor, and mixed in the precontactor prior to entering the polymerization reactor 115. At the precontactor, at least a portion of the polymerization catalyst contacts the solid substrate. The resultant mixture, which includes polymerization catalyst and solid substrate, may be fed to the polymerization reactor 115. At the polymerization reactor 115, the polymerization catalyst contacts the isobutylene. It is noted that the polymerization reaction proceeds when the polymerization catalyst is in the form of a solid (e.g., polymerization catalyst sorbed on the solid substrate) or a liquid (e.g., polymerization catalyst not sorbed on the solid substrate).

The polymerization catalyst may be fed from the polymerization catalyst unit 110 to the optional reactor circulation loop 16 via line 12 and the solid substrate may be fed from the solid substrate unit 120 to the optional reactor circulation loop 16 via line 14. In the optional reactor circulation loop 16, the polymerization catalyst and the solid substrate may contact and then be co-fed to the polymerization reactor 115. The polymerization catalyst and the solid substrate may be added concurrently or sequentially, in any order, to the polymerization reactor 115. The solid substrate may be separately added directly into the polymerization reactor 115 after at least a portion of the PIB (e.g., HR-PIB) is formed.

The solid substrate may be introduced with the polymerization catalyst after the isobutylene polymerization reaction, at a location downstream from the polymerization reactor, or combinations thereof. After introducing the polymerization catalyst to the solid substrate, the solid substrate sorbs at least a portion of the polymerization catalyst. For example, the solid substrate may be introduced after the isobutylene polymerization reaction by introducing the solid substrate into a separate sorption unit or tank where it sorbs the polymerization catalyst from the crude reaction product mixture. This may help ensure that the polymerization catalyst is sufficiently, at least partially, or fully sorbed by the solid substrate prior to downstream separation operations.

As shown in FIG. 1, the reaction product mixture may be removed from the polymerization reactor 115 through line 13 and the solid substrate may then be introduced to the reaction product mixture after removing the reaction product mixture from the polymerization reactor. For example, the reaction product mixture comprising the PIB may be fed from the polymerization reactor 115 to the optional sorption loop 23 via line 13 and the solid substrate may be fed from the solid substrate unit 120 to the optional sorption loop 23 via line 14. In the optional sorption loop 23, the polymerization catalyst and the solid substrate may contact and then be co-fed to the sorber 130.

Additionally, or alternatively, the reaction product mixture comprising PIB may be fed from the polymerization reactor 115 to the sorber 130 via line 13, and the solid substrate may be injected into the sorber 130 where it contacts or sorbs the polymerization catalyst present in the reaction product mixture in the sorber 130. As shown in FIG. 1, the solid substrate may flow from the solid substrate unit 120 to the sorber 130 via the line 14 and into the optional sorption loop 23. Additionally, or alternatively, the solid substrate may be added directly to the sorber 130 and bypass the optional sorption loop 23. The reaction product mixture and the solid substrate may be added concurrently or sequentially, in any order, to the sorber 130.

A combination of methods may be employed. For example, a first portion of solid substrate may be fed to the polymerization reactor 115 and a second portion of the solid substrate may be introduced with the reaction product mixture in the sorber 130 coupled to the polymerization reactor 115. Here, for example, the process 300 may include co-feeding a first portion of the solid substrate with the polymerization catalyst into the polymerization reactor 115 and during the isobutylene polymerization reaction, and introducing a second portion of the solid substrate to the reaction product mixture in a sorber 130 after the polymerization reaction.

Process 300 may further include removing the solid substrate comprising sorbed polymerization catalyst from the reaction product mixture at operation 325. Operation 325 may be performed in the solid-liquid separation unit 140. The removal process of operation 325 may include any suitable solid-liquid separation technique. Suitable solid-liquid separation techniques may include mechanical separation or gravity separation, such as filtration, vacuum filtration, centrifugation, decanting, decanting centrifugation, combinations thereof, among other techniques. As described herein, removing the solid substrate from the reaction product mixture results in an HR-PIB containing composition, for example, a catalyst-depleted effluent. The catalyst-depleted effluent may also be referred to herein as an HR-PIB containing filtrate. The HR-PIB containing filtrate may optionally include additional components such as diluent (e.g., isobutane, hexane, or combinations thereof), unreacted isobutylene, isobutylene oligomer coproducts, or combinations thereof. The HR-PIB containing filtrate and optional additional components may then be subjected to further processing, if desired, as described herein.

Process 300 may further include removing, for example, unreacted isobutylene, diluent (e.g., isobutane, hexane, or combinations thereof), or combinations thereof from the HR-PIB containing filtrate to form a C4-separated effluent. Removal of the unreacted isobutylene, diluent, or combinations thereof may be performed in the C4 separation unit 160. The C4-separaed effluent may exit the C4 separation unit 160 through line 20. The C4-separated effluent exiting the C4 separation unit 160 may include a lower concentration of unreacted isobutylene, diluent (e.g., isobutane, hexane, or combinations thereof), or combinations thereof than the HR-PIB containing filtrate that enters the C4 separation unit 160.

Process 300 may further include removing isobutylene oligomer coproducts from the C4-separated effluent to form an oligomer separated effluent. Removal of the isobutylene oligomer coproducts may be performed in the oligomer separation unit 170. The oligomer separated effluent comprising a polymer composition (e.g., an HR-PIB composition) may exit the oligomer separation unit 170 through line 21. The oligomer separated effluent exiting the oligomer separation unit 170 through line 22 may include a higher concentration of HR-PIB than the C4-separated effluent that enters the oligomer separation unit 170. The oligomer separated effluent exiting the oligomer separation unit 170 may be a highly pure (e.g., >95% pure, such as about 98% or more, such as about 99% or more, such as 100%) PIB composition or HR-PIB composition based on a total wt % of the oligomer separated effluent.

Process 300 may further include cracking the isobutylene oligomer coproducts to form a cracking product effluent comprising isobutylene. Here, the C4-separated effluent exiting the C4 separation unit 160 via line 20 may include isobutylene oligomer coproducts formed during polymerization. The fraction containing isobutylene oligomer coproducts may be removed utilizing oligomer separation unit 170, exiting via line 22. By removing the isobutylene oligomer coproducts, another fraction is collected and includes a high purity PIB, or high purity HR-PIB. The high purity PIB may be collected, thereby exiting the processing plant 100 via line 21. The isobutylene oligomer coproducts may then be flowed via line 22 to the cracking unit 180 which cracks the isobutylene oligomer coproducts to an isobutylene-containing feed (e.g., a cracking product effluent) flowing through line 11.

The process 300 may further include introducing the cracking product effluent comprising isobutylene to the polymerization reactor 115. Additionally, or alternatively, the cracking product effluent may be combined with the isobutylene-containing feed flowing in line 10, and the combined feed may be introduced to the polymerization reactor 115.

Embodiments described herein provide various advantages relative to conventional methods such as environmental benefits, cost reduction, operational flexibility, and scalability. By eliminating water washing and solvent extraction steps, embodiments described herein may dramatically reduce wastewater generation, halogenated residues, and VOC emissions relative to conventional technologies, making it a more sustainable alternative to traditional PIB and HR-PIB production methods.

With respect to cost reduction, embodiments described herein may offer lower capital and operating costs by, for example, minimizing waste treatment requirements and reducing (or eliminating) the need for complex downstream purification systems for removal of halogen-containing species such as HF, HCl, organic fluorides, organic chlorides, or combinations thereof, or other halogen-containing species from the reaction product mixture comprising the PIB. With respect to operational flexibility embodiments of the present disclosure may be utilized to introduce the solid substrate at different stages (e.g., before, during, and/or after the polymerization reaction) and/or locations (e.g., upstream, within, and/or downstream from the polymerization reactor), which provides flexibility in process design and allows for adjustments based on specific production requirements. With respect to scalability, the polymerization reactor (such as a tubular loop reactor) and the sorber (such as a tubular loop sorber) may be scalable, allowing for adaptation to different production volumes without compromising product quality or sorption efficiency. Embodiments described herein are also process efficient. For example, rapid sorption of the BF₃ complex (e.g., sorption times under 4 minutes) reduces the risk of side reactions and allows for continuous, high-throughput production.

Processes and processing plants of the present disclosure may be utilized to yield HR-PIB with greater than 75% alpha-vinylidene content, meeting or exceeding industry standards for HR-PIB. The high content of alpha-vinylidene olefin isomer may be useful for downstream chemical reactivity in lubricant and fuel additive applications.

By allowing flexibility in the composition of the solid substrate, embodiments described herein may be adaptable to different production setups, ensuring that the polymerization catalyst may be sorbed and removed efficiently. This broader scope offers a significant improvement over previous technologies, for example, ensuring complete (or nearly complete) removal of the polymerization catalyst with minimal environmental footprint and enhanced operational performance relative to conventional technologies.

The combination of rapid catalyst removal, precise thermal control, and the use of solid substrates may help ensure that the final HR-PIB composition maintains the desired molecular weight distribution and olefin isomer ratio, making it suitable for high-performance applications in fuel additives and lubricants. Overall, embodiments of the present disclosure may be utilized to provide a highly efficient, cost-effective, and environmentally sustainable process for producing HR-PIB. Embodiments described herein address the long-standing issues of catalyst removal and waste generation in isobutylene polymerization processes, providing a significant advantage in both production efficiency and product quality relative to conventional technologies.

Embodiments described herein include a novel process for manufacturing HR-PIB using, for example, a stable liquid boron trifluoride catalyst complex, such as BF₃·MeOH. Processes and processing plants described herein address the longstanding challenge of removing liquid BF₃ catalysts after the polymerization reaction, traditionally managed through water washing and/or solvent extraction-methods that are expensive, generate significant waste, and present environmental hazards. One innovation described herein includes the use of a solid substrate to sorb the BF₃ catalyst complex during and/or after the polymerization reaction. After sorption, the solid substrate with the BF₃ complex may be removed from the reaction product mixture comprising the PIB through solid-liquid separation techniques, such as filtration or centrifugation. This allows for efficient catalyst removal while maintaining fluorine (F) content in the final product to, for example, less than 10 ppm, eliminating the need for additional fluoride removal systems.

Embodiments described herein provide several flexible methods for introducing the solid substrate. Such methods may include:

(1) Addition of solid substrate before the polymerization reaction and/or contacting the polymerization catalyst with the solid substrate upstream of the polymerization reactor: For example, a pre-made solid catalyst (solid substrate with, for example, a sorbed BF₃ catalyst complex) may be fed to the polymerization reactor, allowing the polymerization reaction to proceed with the catalyst already in solid form.

(2) Addition of solid substrate during the polymerization reaction and/or contacting the polymerization catalyst with the solid substrate in the polymerization reactor: For example, the solid substrate may be added into the polymerization reactor. The liquid BF₃ catalyst complex may be sorbed by the solid substrate during the polymerization reaction, ensuring its removal before any post-reaction separation.

(3) Addition of solid substrate after the reaction and/or contacting the polymerization catalyst with the solid substrate downstream from the polymerization reactor: For example, the solid substrate may be introduced into a separate sorber apparatus, where it sorbs, for example, the liquid BF₃ catalyst complex from the reaction product mixture comprising PIB. This method ensures that the liquid BF₃ catalyst complex may be sufficiently (or fully) removed before any downstream separation steps.

As described herein, combinations of such methods may be utilized.

After the polymerization catalyst, e.g., BF₃ catalyst complex, is sorbed onto the solid substrate, the solid substrate comprising sorbed catalyst may be separated from the reaction product mixture comprising PIB through a process such as such as filtration or centrifugation. The high sorption efficiency ensures that residual fluorine levels in the filtrate may be reduced to, e.g., less than 10 ppm, meeting stringent environmental and product quality standards.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used (e.g. amounts, dimensions, etc.) but some experimental errors and deviations should be accounted for.

### EXAMPLES

Examples of introducing polymerization catalyst and solid substrate are demonstrated in the examples. The examples demonstrate three distinct modes of adding/introducing a polymerization catalyst (for example, BF₃·MeOH polymerization catalyst complex) and a solid substrate (for example, ALS 75 solid substrate): (i) addition of solid substrate after the polymerization reaction (quench addition), (ii) premixing of the polymerization catalyst complex with the solid substrate prior to polymerization (supported catalyst addition), and (iii) co-feeding of the polymerization catalyst complex and solid substrate during the polymerization reaction (in-situ mixing addition). Other modes of introducing polymerization catalyst and solid substrate are contemplated and described herein. The examples show, for example, that efficient sorption and removal of the polymerization catalyst may be achieved regardless of the timing of solid substrate introduction.

In addition to demonstrating these alternative polymerization catalyst-solid substrate addition scenarios, the examples also provide illustrative, but non-limiting, operating conditions used to produce HR-PIB across a broad range of molecular weights. Reaction temperatures for polymerization included non-limiting temperatures in a range from about −7.5° C. to +18° C., with catalyst concentrations adjusted as a function of temperature to, for example, facilitate polymerization to completion in four minutes or less in each case. The resulting data indicate that the process is, for example, robust, yielding products with different molecular weights and viscosities while maintaining high selectivity for HR-PIB. Properties of HR-PIB were determined as described in the Test Methods.

### Materials

Polymerization catalyst complexes presented in the examples include BF₃·MeOH complex. Other polymerization catalysts were investigated and may be advantageously implemented according to embodiments described herein.

Solid substrates presented in the examples include ALS 75. Other solid substrates were investigated and may be advantageously implemented according to embodiments described herein.

### Test Methods

Kinematic viscosity at 100° C. (KV100) was determined according to ASTM D445 XXXX.

Polymer Compositions. The type and amount of each olefin isomer (e.g., alpha vinylidene, beta vinylidene, and other isomers) was determined by ¹³C NMR. ¹³C NMR spectra were collected using a 500 MHz Bruker pulsed Fourier transform NMR spectrometer equipped with a 10 mm Broad Band Observation (BBO) probe at about room temperature. The polymer sample was dissolved in chloroform-d (CDCl₃) and transferred into a 10 mm glass NMR tube. Typical acquisition parameters were inverse-gated (IG) decoupling, a 90° pulse, and a 40 second relaxation delay. Chemical shifts were determined relative to the CDCl₃ signal which is set to about 77.2 ppm. To achieve maximum signal-to-noise for quantitative analysis, multiple data files may be added together. The spectral width was adjusted to include all of the NMR resonances of interest. ¹³C NMR chemical shifts (CDCl₃) for the olefin carbon atoms are provided below in Table 1. All data provided in Table 1 is approximate values. In Table 1, the chemical shift provided corresponds to the carbon underlined.

TABLE 1
¹³C NMR Chemical Shifts of Polymer Compositions

| Type of Olefin Isomer | Chemical Shifts, ppm |
|---|---|
| alpha vinylidene isomer | 143 (RC(CH₃)═CH₂); |
| | 115 (RC(CH₃)═CH₂) |
| beta vinylidene isomer | 136 (RC(H)═C(CH₃)₂); |
| | 128 (RC(H)═C(CH₃)₂) |
| terminal trisubstituted | 134 (RC(CH₃)═CH(CH₃)); |
| vinylidene isomer (1) | 123 (RC(CH₃)═CH(CH₃)) |
| terminal trisubstituted | 139 (RC(H)═C(CH₃)(CH₂CH₃)); |
| vinylidene isomer (2) | 130 (RC(H)═C(CH₃)(CH₂CH₃) |
| terminal tetrasubstituted | 133 (RC(CH₃)═C(CH₃)₂); |
| vinylidene isomer | 122 (RC(CH₃)═C(CH₃)₂) |
| internal disubstituted | 149 (RC(═CH₂)(CH₃)); |
| vinylidene isomer | 111 (RC(═CH₂)(CH₃)) |

When the alpha vinylidene isomer content (wt %) was determined to be about 75 wt % or greater, the polymer composition comprises HR-PIB. When the alpha vinylidene isomer content (wt %) was determined to be less than 75 wt %, the polymer composition comprises a mid-range vinylidene PIB. Generally, HR-PIB has the following content: alpha vinylidene content (≥75 wt % or more); beta vinylidene isomer (<10-15 wt %); terminal trisubstituted vinylidene isomer (1) (<1 wt %); terminal trisubstituted vinylidene isomer (2) (<2-5 wt %); terminal tetrasubstituted vinylidene isomer (<2-5 wt %); internal disubstituted vinylidene isomer (<2-5 wt %).

Polymer molecular weight. Molecular weights (weight-average molecular weight, Mw, number-average molecular weight, Mn), and PDI (Mw/Mn) were determined using gel permeation chromatography (GPC). Equipment included a Waters Alliance 2695 HPLC system with a differential refractive index detector (DRI). A typical GPC procedure was to dissolve the sample to be tested in tetrahydrofuran (THF) at a concentration of about 1 wt % to about 10 wt %. The polymer solution was pumped through a series of columns packed with Styragel beads of known porosity. Typical pore diameters range from about 10,000 Å down to about 50-100 Å, and a typical column string includes a 104 Å column, a 103 Å column, a 1000 Å column and a 2-100 Å column. For example, Waters Styragel HR columns 1, 3, and 4 may be used. The nominal flow rate was about 1.0 ml/min. The various transfer lines, columns, and differential refractometer (the DRI detector) were contained in an oven maintained at about 40° C. Elution solvent was THF. There was a 105-sample carousel for automatic injections. Empower 2 was the software system for controlling the separation and analysis.

The columns were calibrated with known molecular weight standards, both narrow distribution standards and broad distribution standards (for example, polystyrene standards from a molecular weight of 500 to 400K). From the calibration, Mn and Mw were determined for a polymer sample.

Polymer solutions for GPC were prepared by placing the dry polymer in a glass container, adding the desired amount of THF, and then filtering the mixture through a 0.45-micron nylon or polytetrafluoroethylene (PTFE) filter. All quantities were measured gravimetrically. The concentration of polymer to THF was about 10 mg/ml to 20 mg/mL.

Prior to running each sample, the DRI detector and the injector were purged. Flow rate in the apparatus was then increased to about 0.5 ml/minute, and the DRI was allowed to stabilize for about 8 hours to about 9 hours before injecting the first sample. Each sample run takes about one hour to complete.

Isobutylene conversion to PIB and percent yield. Isobutylene conversion to HR-PIB was determined by gas chromatography according to ASTM D424-09 on an Agilent 6890 Gas Chromatograph with dual flame ionization detector using a 30 meter Restek RTX column and Zero grade nitrogen carrier gas at a flow rate of about 30 cc/min with a split ratio of 10. Percent yield of HR-PIB was determined gravimetrically by dividing the weight of the HR-PIB product recovered by the weight of the isobutylene used in the polymerization and multiplying by 100. Selectivity was determined gravimetrically by dividing the weight of the HR-PIB product recovered by the sum of the oligomers and HR-PIB produced and multiplying by 100.

### Example 1: Preparation of HR-PIB Using Liquid BF₃·MeOH Polymerization Catalyst with ALS 75 Solid Substrate Added after Polymerization Reaction (Quench Addition)

A continuous tubular loop polymerization reactor equipped with external heat exchange and high-velocity recirculation was charged with isobutylene feedstock (purity >99.5%). The feed was precooled to −5° C. and introduced into the polymerization reactor at a rate of 1.0 kg/hr.

The liquid polymerization catalyst was prepared as a stable complex of boron trifluoride and methanol (BF₃·MeOH) at a molar ratio of 1.4:1 MeOH to BF₃. The polymerization catalyst was introduced into the polymerization reactor at a concentration of 2,350 ppm by weight, based on the total weight of the polymerization reaction mixture. Polymerization catalyst injection was carried out in liquid form under inert gas conditions to maintain catalyst stability.

The polymerization reactor was operated at a pressure of 150 psig (1.0 MPa) and a bulk temperature of 0° C., with an average residence time of approximately 4 minutes.

Quench and Catalyst Removal. Upon exiting the polymerization reactor, the effluent stream was immediately continuously mixed with ALS 75 solid substrate at a rate sufficient to quench the reaction mixture and collected over a period of time, constituting a batch. The pressure was released, and unreacted isobutylene, along with other light components, was allowed to vent. The mixture was then heated to 60° C. to ensure complete removal of volatile isobutylene and any other lights. Conversion was determined gravimetrically and found to be 92.4%. The deactivated catalyst mixture was subsequently filtered batchwise through a Büchner funnel-type filter to remove the quenched catalyst, yielding a polymer phase essentially free of catalyst residues and light hydrocarbons.

Product Work-Up and Purification. The filtered polymer product, now stripped of residual isobutylene and any other low-boiling components, was subjected to vacuum stripping at 100 mmHg, raising the temperature to 240° C. to remove oligomers and light polymers. This purification yielded a high-purity HR-PIB stream.

Results. The selectivity to HR-PIB was 94.5%, as determined gravimetrically after oligomer removal. The final product was a clear, viscous liquid with a number-average molecular weight (Mn) of 1,300 g/mol and a KV100 of 425 cSt. NMR analysis confirmed that greater than 80% of the polymer chains had alpha vinylidene olefin isomer, consistent with the desired HR-PIB profile. This example illustrates the use of a liquid BF₃·MeOH polymerization catalyst with solid substrate added after the polymerization reaction (e.g., contacting the polymerization catalyst with the solid substrate downstream from the polymerization reactor).

### Example 2: Preparation of HR-PIB with Polymerization Catalyst Complex Premixed with Solid Substrate Before Polymerization Reaction (Supported Catalyst Addition)

A continuous tubular loop polymerization reactor equipped with external heat exchange and high-velocity recirculation was charged with isobutylene feedstock (purity >99.5%). The feed was precooled to −5° C. and introduced into the polymerization reactor at a rate of 1.0 kg/hr.

The polymerization catalyst was prepared as a stable complex of boron trifluoride and methanol (BF₃·MeOH) at a molar ratio of 1.4:1 MeOH to BF₃. The complex was rapidly sorbed onto ALS 75 with only a minor exotherm, yielding a supported polymerization catalyst containing 67.5 wt % BF₃·MeOH complex on the substrate. The supported polymerization catalyst was introduced into the polymerization reactor at a level of 3,500 ppm by weight (corresponding to 2,265 ppm active BF₃·MeOH complex), as a 10% slurry in hexane solvent.

The polymerization reactor was operated at a pressure of 150 psig (1.0 MPa) and a bulk temperature of 18° C., with an average residence time of approximately 4 minutes.

Catalyst Removal and Venting. Upon exiting the polymerization reactor, the effluent stream was passed immediately through an in-line filter to remove the ALS 75-supported polymerization catalyst. This provided a polymer-containing mixture essentially free of polymerization catalyst residues. The reactor pressure was then released, and unreacted isobutylene together with other light components, including the hexane solvent introduced with the catalyst slurry, was vented. The mixture was subsequently heated to 60° C. to ensure complete removal of volatile isobutylene, hexane, and other light compounds. Conversion was determined gravimetrically.

Product Work-Up and Purification. The polymer product was subjected to vacuum stripping at 100 mmHg, raising the temperature to 240° C. to remove oligomers and light polymers. This purification yielded a high-purity HR-PIB stream.

Results. The conversion was 97.0%, as determined gravimetrically. The selectivity to HR-PIB was 90.5%, as determined gravimetrically after oligomer removal. The final product was a clear, viscous liquid with an Mn of 1,000 g/mol and a KV100 of 225 cSt. NMR analysis confirmed that greater than 80% of the polymer chains had alpha vinylidene olefin isomer, consistent with the desired HR-PIB profile. This example illustrates the case where the BF₃·MeOH complex was premixed with the substrate before polymerization reaction (e.g., contacting the polymerization catalyst with the solid substrate upstream of the polymerization reactor).

### Example 3: Preparation of HR-PIB with Polymerization Catalyst Complex and Substrate Co-Fed During Polymerization Reaction (In-Situ Mixing Addition)

A continuous tubular loop reactor equipped with external heat exchange and high-velocity recirculation was charged with isobutylene feedstock (purity >99.5%). The feed was precooled to −5° C. and introduced into the polymerization reactor at a rate of 1.0 kg/hr.

The polymerization catalyst was prepared as a stable complex of boron trifluoride and methanol (BF₃·MeOH) at a molar ratio of 1.4:1 MeOH to BF₃. A portion of the BF₃·MeOH complex was fed directly to the polymerization reactor as liquid, while simultaneously a 10% slurry of ALS 75 solid substrate in hexane was co-fed through a separate line. The feed rates were controlled such that the overall ratio of BF 3. MeOH polymerization catalyst complex to ALS 75 solid substrate was approximately 2:1 by weight. This method provided intimate mixing of the complex and substrate within the reactor loop under polymerization conditions. The total catalyst concentration corresponded to 3,200 ppm active BF₃·MeOH complex based on the total weight of the polymerization reaction mixture.

The polymerization reactor was operated at a pressure of 150 psig (1.0 MPa) and a bulk temperature of −7.5° C., with an average residence time of approximately 4 minutes.

Catalyst Removal and Venting. Upon exiting the polymerization reactor, the effluent stream was continuously passed through an in-line filter to remove the ALS 75-supported catalyst formed in situ. This provided a polymer-containing mixture essentially free of catalyst residues. The reactor pressure was then released, and unreacted isobutylene together with other light components, including the hexane solvent introduced with the solid substrate slurry, was vented. The mixture was subsequently heated to 60° C. to ensure complete removal of volatile isobutylene, hexane, and other lights. Conversion was determined gravimetrically.

Product Work-Up and Purification. The polymer product was subjected to vacuum stripping at 100 mmHg, raising the temperature to 240° C. to remove oligomers and light polymers. This purification yielded a high-purity HR-PIB stream.

Results. The conversion was 62.5%, as determined gravimetrically. The selectivity to high-reactive PIB was 97.1%, as determined gravimetrically after oligomer removal. The final product was a clear, viscous liquid with an Mn of 2,230 g/mol and a KV100 of 1,605 cSt. NMR analysis confirmed that greater than 80% of the polymer chains had alpha vinylidene olefin isomer, consistent with the desired HR-PIB profile.

This example illustrates the case where the polymerization catalyst (BF₃·MeOH complex) and solid substrate were co-fed during the reaction, corresponding to an in-situ mixing addition scenario (e.g., contacting the polymerization catalyst with the solid substrate in the polymerization reactor).

Table 2 shows a summary of the representative experimental examples.

TABLE 2

| | Mode of | Temp. | Time, | Conversion, | Selectivity, | Mn, | KV100, |
|---|---|---|---|---|---|---|---|
| Example | addition | ° C. | min | wt % | wt % | g/mol | cSt |
| Ex. 1 | After | 0 | 4 | 92.4 | 94.5 | 1,300 | 425 |
| Ex. 2 | Pre- | 18 | 4 | 97.0 | 90.5 | 1,000 | 225 |
| | mixed | | | | | | |
| Ex. 3 | Co-feed | −7.5 | 4 | 62.5 | 97.1 | 2,230 | 1,605 |

### Embodiments Listing

The present disclosure provides, among others, the following embodiments, each of which may be considered as optionally including any alternate embodiments:

Embodiment A1. A process for producing highly reactive polyisobutylene (HR-PIB), the process comprising:
introducing isobutylene into a polymerization reactor;
introducing a polymerization catalyst with the isobutylene to form a mixture comprising the isobutylene and the polymerization catalyst, the polymerization catalyst comprising a Lewis acid catalyst;
reacting the mixture to form a reaction product mixture comprising an HR-PIB;
introducing a solid substrate with the reaction product mixture, the solid substrate having a capacity to (or capable of) sorbing an amount of polymerization catalyst such that the resultant solid substrate comprising sorbed polymerization catalyst has a concentration of the polymerization catalyst that is about 1 wt % or more (calculated as wt % of Lewis acid catalyst, for example, calculated as wt % of BF₃) based on a total wt % of the solid substrate comprising sorbed polymerization catalyst, the total wt % of the solid substrate comprising sorbed polymerization catalyst equal to 100 wt %; and
removing the solid substrate comprising sorbed polymerization catalyst from the reaction product mixture by solid-liquid separation.

Embodiment A2. The process according to Embodiment A1, wherein the solid substrate is introduced into the polymerization reactor and contacts the reaction product mixture in the polymerization reactor.

Embodiment A3. The process according to any one of Embodiments A1-A2, wherein:
the solid substrate and the polymerization catalyst are co-fed to the polymerization reactor in a single stream;
the solid substrate is separately added into the polymerization reactor after at least a portion of the HR-PIB is formed; or
a combination thereof.

Embodiment A4. The process according to any one of Embodiments A1-A3, wherein the introducing the polymerization catalyst with the isobutylene comprises introducing a polymerization catalyst into the polymerization reactor as a liquid BF₃·MeOH catalyst complex.

Embodiment A5. The process according to any one of Embodiments A1-A4, wherein the polymerization catalyst and the solid substrate are co-fed into the polymerization reactor as separate streams.

Embodiment A6. The process according to any one of Embodiments A1-A5, wherein the process further comprises:
removing the reaction product mixture comprising the HR-PIB from the polymerization reactor; and then
introducing the solid substrate with the reaction product mixture after the removing the reaction product mixture from the polymerization reactor and prior to the removing the solid substrate comprising sorbed polymerization catalyst from the reaction product mixture by the solid-liquid separation.

Embodiment A7. The process according to any one of Embodiments A1-A6, wherein, prior to the removing the solid substrate comprising sorbed polymerization catalyst from the reaction product mixture by the solid-liquid separation, the process further comprises:
introducing the reaction product mixture to a sorber, the sorber positioned coupled to the polymerization reactor and positioned downstream from the polymerization reactor

Embodiment A8. The process according to any one of Embodiments A1-A7, wherein, prior to introducing the solid substrate to the reaction product mixture, the process further comprises:
feeding the reaction product mixture from the polymerization reactor into a sorber (for example, a tubular loop sorber) located downstream from the polymerization reactor; and then
introducing the solid substrate to the reaction product mixture in the sorber, where it contacts or sorbs the polymerization catalyst present in the reaction product mixture (for example, liquid polymerization catalyst, for example, Lewis acid catalyst).

Embodiment A9. The process according to any one of Embodiments A1-A8, wherein:
a first portion of the solid substrate is co-fed with the polymerization catalyst (for example, liquid polymerization catalyst, for example, Lewis acid catalyst) to the polymerization reactor; and
a second portion of the solid substrate is introduced to the reaction product mixture in a sorber coupled to the polymerization reactor, the sorber positioned downstream from the polymerization reactor.

Embodiment A10. The process according to any one of Embodiments A1-A9, wherein the sorber comprises a tubular loop sorber.

Embodiment A11. The process according to Embodiment A10, wherein:
the tubular loop sorber comprises a series of sorber tubes arranged in a loop configuration; and/or
the tubular loop sorber comprises in-line circulation pumps that maintain a high flow rate, recirculating the reaction product mixture through the sorber tubes; and/or
the tubular loop sorber is configured to provide:
   high velocity flow to ensure thorough mixing of the reaction product mixture and the solid substrate;
   sufficient residence time within the tubular loop sorber, ensuring rapid and complete sorption of the polymerization catalyst (for example, liquid BF₃ catalyst complex) onto the solid substrate; or a
   combination thereof.

Embodiment A12. The process according to any one of Embodiments A10-All, wherein the tubular loop sorber operates with a circulation rate to feed flow rate ratio of 20:1 to 75:1, ensuring adequate turbulence for solid substrate dispersion and rapid liquid catalyst complex sorption within 4 minutes or less.

Embodiment A13. The process according to any one of Embodiments A10-A12, wherein the tubular loop sorber comprises a multi-pass tube-in-shell heat exchanger, wherein the reaction product mixture flows through tubes of the tubular loop sorber and a cooling medium circulates through shells of the tubular loop sorber to maintain temperature control.

Embodiment A14. The process according to any one of Embodiments A7-A13, wherein the sorber (for example, a tubular loop sorber) includes one or more solid substrate injection points configured to directly inject the solid substrate during and/or after polymerization of the isobutylene.

Embodiment A15. The process according to any one of Embodiments A7-A14, wherein the sorber is configured to allow for continuous operation, maintaining constant contact between the reaction product mixture and the solid substrate.

Embodiment A16. The process according to any one of Embodiments A7-A15, wherein the loop sorber is scalable.

Embodiment A17. The process according to any one of Embodiments A1-A16, wherein:
the removing the solid substrate comprising sorbed polymerization catalyst from the reaction product mixture by solid-liquid separation forms an HR-PIB containing filtrate; and
a halogen content (for example, fluorine content) in the HR-PIB containing filtrate is less than 100 ppm, such as less than 50 ppm, such as less than 10 ppm.

Embodiment A18. The process according to any one of Embodiments A1-A17, wherein after the removing the solid substrate comprising sorbed polymerization catalyst by the solid-liquid separation, the process further comprises:
removing unreacted isobutylene from the reaction product mixture; and
optionally, removing oligomeric coproducts from the reaction product mixture to provide yield the HR-PIB.

Embodiment A19. The process according to any one of Embodiments A1-A18, wherein the introducing the polymerization catalyst with the isobutylene comprises:
introducing (e.g., injecting) the polymerization catalyst directly to the polymerization reactor;
introducing (e.g., injecting) the polymerization catalyst to a feed comprising the isobutylene prior to entering the polymerization reactor; or
a combination thereof.

Embodiment A20. The process according to any one of Embodiments A1-A19, wherein the polymerization catalyst introduced into the polymerization reactor comprises a gaseous Lewis acid catalyst (for example, BF₃ gas).

Embodiment A21. The process according to Embodiment A20, wherein the solid substrate comprises sorbed complexing agent.

Embodiment A22. The process according to any one of Embodiments A1-A21, wherein the polymerization catalyst comprises a pre-formed solid catalyst comprising a solid impregnated with liquid Lewis acid catalyst complex (for example, a BF₃ catalyst complex).

Embodiment A23. The process according to Embodiment A22, wherein, prior to the reacting the mixture to form the reaction product mixture comprising HR-PIB, the process further comprises:
feeding the pre-formed solid catalyst into the polymerization reactor or co-feeding the pre-formed solid catalyst with the isobutylene into the polymerization reactor.

Embodiment A24. The process according to any one of Embodiments A22-A23, wherein the pre-formed solid catalyst is prepared by sorbing a Lewis acid catalyst complex (for example, a liquid BF₃ catalyst complex) onto a solid substrate prior to its introduction into the polymerization reactor.

Embodiment A25. The process according to any one of Embodiments A1-A24, wherein the polymerization catalyst introduced to the polymerization reactor comprises a liquid Lewis acid catalyst complex, the Lewis acid catalyst complex comprising:
a Lewis acid catalyst; and
a complexing agent.

Embodiment A26. The process according to Embodiment A25, wherein the complexing agent comprises an oxygen-containing compound (also referred to as oxygenate).

Embodiment A27. The process according to Embodiment A26, wherein the oxygen-containing compound is free of beta-hydrogen atoms.

Embodiment A28. The process according to any one of Embodiments A26-A27, wherein the oxygen-containing compound comprises methanol, a 2,2-dimethyl alcohol (for example, neopentyl alcohol, 2,2-dimethylbutanol, 2,2-dimethylpentanol, and 2,2-dimethylhexanol), benzyl alcohol, a ring-substituted benzyl alcohol, or combinations thereof.

Embodiment A29. The process according to any one Embodiments A25-A28, wherein the Lewis acid catalyst comprises a fluorine-containing material, a chlorine-containing material, or combinations thereof.

Embodiment A30. The process according to Embodiment A29, wherein the fluorine-containing material comprises boron trifluoride (BF₃), tris(pentaflurophenyl)borane (C₆F₅)₃B, or a combination thereof.

Embodiment A31. The process according to any one of Embodiments A29-A30, wherein the chlorine-containing material comprises a metal chloride (for example, AlCl₃, ZnCl₂, SnC₁₄, TiCl₄), a metal alkyl chloride (for example, ethylalumium dichloride (EtAlCl₂)), or combinations thereof.

Embodiment A32. The process according to any one of Embodiments A1-A31, wherein the polymerization catalyst comprises a BF₃-methanol (BF₃·MeOH) complex.

Embodiment A33. The process according to any one of Embodiments A1-A32, wherein the solid substrate has the capacity to sorb an amount of polymerization catalyst such that the resultant solid substrate comprising sorbed polymerization catalyst (for example, a Lewis acid catalyst, such as BF₃ catalyst complex) such that the resultant solid substrate comprising sorbed polymerization catalyst has a concentration of polymerization catalyst that is about 5 wt % or more, such as about 10 wt % or more, such as about 15 wt % or more, such as about 20 wt % or more, such as about 25 wt % or more, such as about 30 wt % or more, such as about 35 wt % or more, such as about 40 wt % or more (calculated as wt % of the Lewis acid catalyst, for example, wt % of BF₃) based on the total wt % of the solid substrate comprising sorbed polymerization (with a maximum of 100 wt %)).

Embodiment A34. The process according to any one of Embodiments A1-A33, wherein the solid substrate comprises any suitable material capable of sorbing a Lewis acid catalyst and/or a Lewis acid catalyst complex.

Embodiment A35. The process according to Embodiment A34, wherein:
the solid substrate comprises Al₂O₃, SiO₂, ZrO₂, TiO₂, SnO₂, CeO₂, or combinations thereof, such as SiO₂/Al₂O₃;
the solid substrate is selected from the group consisting of Al₂O₃, ZrO₂, TiO₂, SnO₂, CeO₂, SiO₂, SiO₂/Al₂O₃, and combinations thereof, such as SiO₂/Al₂O₃; or combinations thereof.

Embodiment A36. The process according to any one of Embodiments A34-A35, wherein the solid substrate comprises an Al₂O₃ content that is in a range from about 25 wt % to about 75 wt %, such as from about 25 wt % to about 50 wt % based on a total wt % of the solid substrate, the total wt % of the solid substrate equal to 100 wt %.

Embodiment A37. The process according to any one of Embodiments A34-A36, wherein the solid substrate comprises an SiO₂ content greater than about 45 wt % based on a total wt % of the solid substrate, the total wt % of the solid substrate equal to 100 wt %.

Embodiment A38. The process according to any one of Embodiments A1-A37, wherein the process is a continuous process or a batch process.

Embodiment A39. The process according to any one of Embodiments A1-A38, wherein the polymerization reactor comprises a batch reactor, a tank reactor, tubular loop reactor, a continuous stirred tank reactor (CSTR), a plug flow reactor, a fluidized bed reactor, an immobilized bed reactor, a fixed bed reactor, or combinations thereof.

Embodiment A40. The process according to any one of Embodiments A1-A39, wherein the polymerization catalyst is introduced at a concentration sufficient to catalyze an isobutylene polymerization reaction.

Embodiment A41. The process according to any one of Embodiments A1-A40, wherein the reacting the mixture to form the reaction product mixture comprising the HR-PIB is performed under reaction conditions, the reaction conditions comprising:
maintaining isothermal conditions within the polymerization reactor to control a molecular weight of the HR-PIB;
allowing for a predetermined isobutylene residence time in the polymerization reactor to convert isobutylene to HR-PIB; or
a combination thereof.

Embodiment A42. The process according to any one of Embodiments A1-A41, wherein the solid-liquid separation for removing the solid substrate containing the sorbed polymerization catalyst (for example, liquid BF₃ catalyst complex) comprises filtration, vacuum filtration, centrifugation, decanting, decanting centrifugation, or combinations thereof.

Embodiment A43. The process according to any one of Embodiments A1-A42, wherein sorption of the polymerization catalyst (for example, liquid BF₃ catalyst complex) onto the solid substrate occurs in about 4 minutes or less.

Embodiment A44. The process according to any one of Embodiments A1-A43, wherein the HR-PIB comprises greater than greater than 75 wt % alpha-vinylidene olefin isomer based on a total wt % of the HR-PIB, the total wt % of the HR-PIB equal to 100 wt %.

Embodiment B1. A processing plant or system for producing PIB (for example, HR-PIB), configured to perform processes of any one of Embodiments A1-A44.

Embodiment B2. A processing plant or system for producing (for example, continuous production of) HR-PIB, comprising:
a tubular loop reactor configured to perform isobutylene polymerization and form a reaction product mixture comprising HR-PIB;
a tubular loop sorber coupled to the tubular loop reactor and positioned downstream from the tubular loop reactor, the tubular loop sorber configured to facilitate sorption of a polymerization catalyst (for example, liquid BF₃ catalyst complex) present in the reaction product mixture onto a solid substrate, the tubular loop sorber equipped with one or more in-line circulation pumps (e.g., configured to maintain high flow rates) and a multi-pass tube-in-shell heat exchanger (e.g., configured to control a temperature of the reaction product mixture during sorption); and
a solid-liquid separation unit coupled to the tubular loop sorber and positioned downstream from the tubular loop sorber, the solid-liquid separation unit configured to separate or remove the solid substrate comprising sorbed polymerization catalyst from the reaction product mixture and to provide an HR-PIB containing filtrate.

Embodiment B2. The processing plant or system according to Embodiment B1, wherein the tubular loop reactor is further configured to:
receive a feed comprising isobutylene;
receive a feed comprising the polymerization catalyst;
react a mixture comprising isobutylene and polymerization catalyst to form the reaction product mixture comprising the HR-PIB;
discharge the reaction product mixture comprising the HR-PIB; or
combinations thereof.

Embodiment B3. The processing plant or system according to any one of Embodiments B1-B2, wherein the tubular loop sorber is further configured to:
receive the reaction product mixture comprising the HR-PIB from the tubular loop reactor;
receive the solid substrate;
discharge the reaction product mixture comprising the HR-PIB and sorbed polymerization catalyst; or
combinations thereof.

Embodiment B4. The processing plant or system according to any one of Embodiments B1-B3, wherein the solid-liquid separation is further configured to: receive the reaction product mixture comprising the HR-PIB and solid substrate
comprising sorbed polymerization catalyst;
discharge the HR-PIB containing filtrate;
discharge the solid substrate comprising sorbed polymerization catalyst; or combinations thereof.

Embodiment B5. The processing plant or system according to any one of Embodiments B1-B4, further comprising a first separation unit coupled to the solid-liquid separation unit and positioned downstream from the solid-liquid separation unit, the first separation unit configured to:
receive the HR-PIB containing filtrate;
remove unreacted isobutylene, diluent (e.g., isobutane, hexane, or combinations thereof), or a combination thereof from the HR-PIB containing filtrate;
discharge a C4-separated effluent; or
combinations thereof.

Embodiment B6. The processing plant according to any one of Embodiments B1-B5, further comprising a second separation unit coupled to the first separation unit and positioned downstream from the first separation unit, the second separation unit configured to:
receive the C4-separated effluent;
remove isobutylene oligomer coproducts from the C4-separated effluent;
discharge an oligomer separated effluent comprising the HR-PIB;
discharge isobutylene oligomer coproducts; or
combinations thereof.

Embodiment B7. The processing plant according to any one of Embodiments B1-B6, further comprising a cracking unit coupled to the second separation unit and positioned downstream from the second separation unit, the cracking unit configured to:
receive the isobutylene oligomer coproducts;
crack the isobutylene oligomer coproducts to form isobutylene;
discharge a cracking product effluent comprising isobutylene; or
a combination thereof.

Embodiment B8. The processing plant according to Embodiment B7, wherein the cracking unit is coupled to the polymerization reactor.

Embodiment B9. The processing plant according to any one of Embodiments B1-B7, wherein the polymerization reactor is further configured to receive the cracking product effluent comprising isobutylene.

Embodiment C1. A process (for example, a continuous process) for producing HR-PIB, the process comprising:
feeding an isobutylene-containing stream into a polymerization reactor;
injecting a polymerization catalyst (for example, a stable liquid BF₃ catalyst complex) into the isobutylene-containing stream at a concentration sufficient to catalyze an isobutylene polymerization reaction;
allowing for a predetermined residence time in the polymerization reactor to convert isobutylene to HR-PIB;
maintaining isothermal conditions within the polymerization reactor to control a molecular weight of the HR-PIB;
introducing a solid substrate capable of sorbing an amount of the BF₃ catalyst complex such that the resultant solid substrate with BF₃ catalyst complex sorbed has a concentration of BF₃ that is about 1 wt % or more (calculated as BF₃), into a reaction mixture, wherein the solid substrate is added before, during, and/or after the isobutylene polymerization reaction;
passing the crude reaction mixture from the isobutylene polymerization reaction into a tubular loop sorber to efficiently contact the solid substrate with the liquid BF₃ catalyst complex;
removing the solid substrate comprising sorbed BF₃ catalyst complex through a solid-liquid separation technique;
distilling unreacted isobutylene in a first distillation column; and
optionally, removing isobutylene oligomer coproducts in a second distillation column to yield a final HR-PIB product.

Embodiment C2. The process of according to Embodiment C1, wherein the solid substrate is capable of sorbing an amount of the BF₃ catalyst complex such that the resultant solid substrate with catalyst sorbed has a concentration of BF₃ that is about 30 wt % or more (calculated as BF₃).

Embodiment C3. The process according to any one of Embodiments C1-C₂, wherein the solid substrate is pre-impregnated with the liquid BF₃ catalyst complex before the isobutylene polymerization reaction. This method may involve:
preparing a solid catalyst by sorbing the liquid BF₃ catalyst complex onto the solid substrate prior to its introduction into the polymerization reactor; and
feeding the pre-formed solid catalyst into the polymerization reactor or co-feeding the pre-formed solid catalyst with the isobutylene into the polymerization reactor, allowing the isobutylene polymerization reaction to proceed with the catalyst already in solid form.

Embodiment C4. The process according to any one of Embodiments C₁-C₃, wherein the solid substrate is introduced during the isobutylene polymerization reaction, by:
co-feeding the solid substrate and the liquid BF₃ catalyst complex with the isobutylene-containing feed into the polymerization reactor;
separately introducing (e.g., injecting) the solid substrate directly into the polymerization reactor during the isobutylene polymerization reaction, ensuring the liquid BF₃ catalyst complex is sorbed in situ; or
a combination thereof.

Embodiment C5. The process according to any one of Embodiments C₁-C₄, wherein the solid substrate is introduced after the isobutylene polymerization reaction, by:
introducing the solid substrate into a separate sorption unit or tank where it sorbs the liquid BF₃ catalyst complex from the crude reaction mixture; and
ensuring that the liquid BF₃ catalyst complex is sufficiently (or fully) sorbed by the solid substrate before downstream separation steps.

Embodiment C6. The process according to any one of Embodiments C₁-C₅, wherein a combination of methods is employed comprising: co-feeding a portion of the solid substrate with the liquid BF₃ catalyst complex during the isobutylene polymerization reaction, while the remaining portion of the solid substrate is introduced in a separate sorber apparatus after the reaction to ensure catalyst sorption, or almost complete catalyst sorption, or complete catalyst sorption.

Embodiment C7. The process according to any one of Embodiments C₁-C₆, wherein the tubular loop sorber comprises a series of tubes arranged in a loop configuration, and configured to provide:
high velocity flow to ensure thorough mixing of the reaction mixture and the solid substrate;
in-line circulation pumps that maintain a high flow rate, recirculating the reaction mixture through the sorber tubes; and/or
sufficient residence time within the tubular loop, ensuring rapid and complete sorption of the liquid BF₃ catalyst complex onto the solid substrate.

Embodiment C8. The process according to any one of Embodiments C1-C7, wherein the tubular loop sorber operates with a circulation rate to feed flow rate ratio of 20:1 to 75:1, ensuring adequate turbulence for solid substrate dispersion and rapid liquid catalyst complex sorption within 4 minutes or less.

Embodiment C9. The process according to any one of Embodiments C1-C8, wherein the tubular loop sorber comprises a multi-pass tube-in-shell heat exchanger, wherein:
the reaction mixture flows through the tubes and a cooling medium circulates through the shell to maintain temperature control, preventing thermal degradation of the liquid BF₃ catalyst complex during sorption onto the solid substrate.

Embodiment C10. The process according to any one of Embodiments C1-C9, wherein the tubular loop sorber includes one or more solid substrate injection points, configured to allow:
direct injection of the solid substrate during and/or after the isobutylene polymerization reaction for enhanced sorption and complete (or nearly complete) removal of the liquid BF₃ catalyst complex.

Embodiment C11. The process according to any one of Embodiments C1-C10, wherein the tubular loop sorber is configured to allow for continuous operation, maintaining constant contact (or at least some contact) between the reaction mixture and the solid substrate, ensuring efficient sorption and removal (or at least partial removal) of the liquid BF₃ catalyst complex.

Embodiment C12. The process according to any one of Embodiments C1-C11, wherein the tubular loop sorber promotes, or is configured to promote, filtration-ready substrate output, ensuring that the solid substrate comprising the sorbed BF₃ catalyst complex may be easily separated by filtration or centrifugation, reducing fluoride (F) contents in the final filtrate to about 1,000 ppm or less, such as about 100 ppm or less, such as about 10 ppm or less.

Embodiment C13. The process according to any one of Embodiments C1-C12, wherein the tubular loop sorber design is scalable, with the ability to adjust tube lengths, circulation rates, and cooling capacities to accommodate higher production volumes without sacrificing efficiency or product quality.

Embodiment C14. The process according to any one of Embodiments C1-C13, wherein the solid substrate is selected based on its ability to sorb an amount of the BF₃ catalyst complex such that the resultant solid substrate with BF₃ catalyst complex sorbed has a concentration of BF₃ that is about 25 wt % or more (calculated as BF₃), and may be composed of any suitable material capable of maintaining high sorption capacity during removal of liquid BF₃ catalyst complex.

Embodiment C15. The process according to any one of Embodiments C1-C14, wherein the solid-liquid separation technique for removing the solid substrate comprising the sorbed BF₃ catalyst complex comprises filtration, centrifugation, or a combination thereof.

Embodiment C16. The process according to any one of Embodiments C1-C15, wherein the sorption of the liquid BF₃ catalyst complex onto the solid substrate occurs in about 4 minutes or less, preventing side reactions and/or ensuring efficient removal (or at least partial removal) of the liquid BF₃ catalyst complex.

Embodiment C17. The process according to any one of Embodiments C1-C16, wherein the stable liquid BF₃ catalyst complex comprises:
a BF₃-methanol (BF₃·MeOH) complex; and/or
any suitable BF₃-oxygenated compound complex that is free of beta-hydrogen atoms, thus preventing beta-elimination reactions during the polymerization of isobutylene, wherein the oxygenated compound (oxygen-containing compound) may include methanol, 2,2-dimethyl alcohols (for example, neopentyl alcohol, 2,2-dimethylbutanol, 2,2-dimethylpentanol, and 2,2-dimethylhexanol), benzyl alcohol, ring-substituted benzyl alcohols, or combinations thereof.

Embodiment C18. The process according to any one of embodiments 1-17, wherein the final HR-PIB product contains greater than 75% alpha-vinylidene olefin isomer, enhancing its reactivity for use in lubricant and fuel additive applications.

Embodiment D1. A system (for example, a plant or a facility) for the continuous manufacture of HR-PIB, comprising:
a tubular loop reactor for isobutylene polymerization;
a tubular loop sorber configured to sorb a liquid BF₃ catalyst complex onto a solid substrate, wherein the sorber is equipped with in-line circulation pumps to maintain high flow rates and a multi-pass tube-in-shell heat exchanger for temperature control during sorption;
a solid-liquid separation unit configured to separate or remove the solid substrate comprising the sorbed polymerization catalyst;
a first distillation column configured to remove unreacted isobutylene; and
a second distillation column configured to remove isobutylene oligomer coproducts to yield the final HR-PIB product.

Embodiment E1. A process (for example, a continuous process) for producing HR-PIB, the process comprising:
feeding an isobutylene-containing stream into a polymerization reactor;
injecting an amount of polymerization catalyst into the polymerization reactor stream to form a mixture comprising isobutylene and polymerization catalyst, the amount of polymerization catalyst is sufficient to catalyze an isobutylene polymerization reaction to form HR-PIB, the polymerization catalyst comprising a Lewis acid catalyst;
optionally maintaining isothermal conditions within the polymerization reactor to control a molecular weight of the HR-PIB;
introducing a solid substrate with the mixture, the solid substrate capable of sorbing an amount of the polymerization catalyst such that the resultant solid substrate comprising sorbed polymerization catalyst has a concentration of polymerization catalyst that is about 1 wt % or more (calculated as wt % of Lewis acid catalyst, for example, wt % of BF₃) based on a total wt % of the solid substrate comprising sorbed polymerization catalyst, the total wt % of the solid substrate comprising sorbed polymerization catalyst equal to 100 wt %, wherein the solid substrate is introduced before, during, and/or after the isobutylene polymerization reaction; and
removing the solid substrate comprising sorbed polymerization catalyst from the mixture by solid-liquid separation.

Embodiment E2. The process of according to Embodiment C1, further comprising one or more of:
passing the mixture from the isobutylene polymerization reactor into a sorber;
distilling unreacted isobutylene from the mixture in a first distillation column;
and optionally, removing isobutylene oligomer coproducts from the mixture in a second distillation column to yield a final HR-PIB product.

Embodiment E3. The process of according to any one of Embodiments E1-E2, wherein the solid substrate is capable of sorbing an amount of the polymerization catalyst (for example, BF₃ catalyst complex) such that the resultant solid substrate comprising sorbed polymerization catalyst has a concentration of polymerization catalyst that is about 30 wt % or more (calculated as wt % of Lewis acid catalyst, for example, wt % of BF₃).

Embodiment E4. The process according to any one of Embodiments E1-E3, wherein the solid substrate is pre-impregnated with a liquid polymerization catalyst before the isobutylene polymerization reaction. This method may involve:
preparing a solid catalyst by sorbing the liquid polymerization catalyst onto the solid substrate prior to its introduction into the polymerization reactor; and
feeding the pre-formed solid catalyst into the polymerization reactor or co-feeding the pre-formed solid catalyst with the isobutylene into the polymerization reactor, allowing the isobutylene polymerization reaction to proceed with the catalyst already in solid form.

Embodiment E5. The process according to any one of Embodiments E1-E4, wherein the solid substrate is introduced during the isobutylene polymerization reaction, by:
co-feeding the solid substrate and the liquid polymerization catalyst with the isobutylene-containing stream into the polymerization reactor;
separately introducing (e.g., injecting) the solid substrate directly into the polymerization reactor during the isobutylene polymerization reaction, ensuring the liquid polymerization catalyst is sorbed in situ; or
a combination thereof.

Embodiment E6. The process according to any one of Embodiments E1-E5, wherein the solid substrate is introduced after the isobutylene polymerization reaction by introducing the solid substrate into a separate sorption unit or tank where it sorbs the liquid polymerization catalyst from the mixture.

Embodiment E7. The process according to any one of Embodiments E1-E6, wherein a combination of methods is employed comprising: co-feeding a portion of the solid substrate with the liquid polymerization catalyst during the isobutylene polymerization reaction, while the remaining portion of the solid substrate is introduced in a separate sorber apparatus after the isobutylene polymerization reaction.

Embodiment E8. The process according to any one of Embodiments E1-E7, wherein: (a) the sorber comprises a series of sorber tubes arranged in a loop configuration; (b) the sorber comprises an in-line circulation pump that maintains a high flow rate and recirculates the mixture through the sorber tubes; and/or (c) the sorber is configured to provide high velocity flow to ensure thorough mixing of the mixture with the solid substrate;

Embodiment E9. The process according to any one of Embodiments E1-E8, wherein the sorber operates with a circulation rate to feed flow rate ratio of 20:1 to 75:1 for liquid polymerization catalyst sorption within about 4 minutes or less.

Embodiment E10. The process according to any one of Embodiments E1-E9, wherein the sorber comprises a multi-pass tube-in-shell heat exchanger, wherein the mixture flows through a tube of the sorber and a cooling medium circulates through a shell of the sorber.

Embodiment E11. The process according to any one of Embodiments E1-E10, wherein the sorber includes one or more solid substrate injection points.

Embodiment E12. The process according to any one of Embodiments E1-E11, wherein the sorber is configured for continuous operation.

Embodiment E13. The process according to any one of Embodiments E1-E12, wherein: (a) the removing the solid substrate comprising sorbed polymerization catalyst from the mixture by solid-liquid separation forms an HR-PIB containing filtrate; and (b) a fluorine level in the HR-PIB containing filtrate is less than 100 ppm.

Embodiment E14. The process according to any one of Embodiments E1-E13, wherein the tubular loop sorber design is scalable, with the ability to adjust tube lengths, circulation rates, and cooling capacities to accommodate higher production volumes without sacrificing efficiency or product quality.

Embodiment E15. The process according to any one of Embodiments E1-E14, wherein the solid substrate is selected based on its ability to sorb an amount of BF₃ catalyst complex such that the resultant solid substrate with BF₃ catalyst complex sorbed has a concentration of BF₃ that is about 25 wt % or more.

Embodiment E16. The process according to any one of Embodiments E1-E15, wherein the solid-liquid separation for removing the solid substrate comprising the sorbed polymerization catalyst comprises filtration, centrifugation, or a combination thereof.

Embodiment E17. The process according to any one of Embodiments E1-E16, wherein sorption of the liquid polymerization catalyst onto the solid substrate occurs in about 4 minutes or less.

Embodiment E18. The process according to any one of Embodiments E1-E17, wherein the polymerization catalyst comprises:
a BF₃-methanol (BF₃·MeOH) complex; and/or
any suitable BF₃-oxygenated compound complex, wherein the oxygenated compound of the complex is free of beta-hydrogen atoms.

Embodiment E19. The process according to any one of Embodiments E1-E18, wherein the final HR-PIB product contains greater than 75% alpha-vinylidene olefin isomer.

Embodiment F1. A process for producing highly reactive polyisobutylene (HR-PIB), the process comprising:
introducing a polymerization catalyst with isobutylene to form a mixture comprising the isobutylene and the polymerization catalyst, the polymerization catalyst comprising a Lewis acid catalyst;
reacting the mixture to form a reaction product mixture comprising an HR-PIB;
sorbing the polymerization catalyst onto a solid substrate, the resultant solid substrate comprising sorbed polymerization catalyst having a concentration of the polymerization catalyst that is about 1 wt % or more (calculated as wt % of Lewis acid catalyst) based on a total wt % of the solid substrate comprising sorbed polymerization catalyst, the total wt % of the solid substrate comprising sorbed polymerization catalyst equal to 100 wt %; and
removing the solid substrate comprising sorbed polymerization catalyst from the reaction product mixture by solid-liquid separation.

Embodiment F2. The process according to Embodiment F11, wherein sorbing the polymerization catalyst onto the solid substrate occurs:
in a polymerization reactor;
upstream of a polymerization reactor;
downstream of a polymerization reactor; or
combinations thereof.

Embodiment F3. The process according to Embodiment F2, wherein the solid substrate is introduced into the polymerization reactor and contacts the reaction product mixture in the polymerization reactor.

Embodiment F4. The process according to any one of Embodiments F2-F3, wherein:
the solid substrate and the polymerization catalyst are co-fed to the polymerization reactor in a single stream;
the solid substrate is separately added into the polymerization reactor after at least a portion of the HR-PIB is formed; or a combination thereof.

Embodiment F5. The process according to any one of Embodiments F2-F4, wherein introducing the polymerization catalyst with the isobutylene comprises introducing the polymerization catalyst into the polymerization reactor as a liquid BF₃·MeOH catalyst complex.

Embodiment F6. The process according to any one of Embodiments F2-F5, wherein the polymerization catalyst and the solid substrate are co-fed into the polymerization reactor as separate streams.

Embodiment F7. The process according to any one of Embodiments F2-F6, wherein the process further comprises:
removing the reaction product mixture comprising the HR-PIB from the polymerization reactor; and then
introducing the solid substrate with the reaction product mixture after removing the reaction product mixture from the polymerization reactor and prior to removing the solid substrate comprising sorbed polymerization catalyst from the reaction product mixture by the solid-liquid separation.

Embodiment F8. The process according to any one of Embodiments F2-F7, wherein:
a first portion of the solid substrate is co-fed with the polymerization catalyst to the polymerization reactor; and
a second portion of the solid substrate is introduced to the reaction product mixture in a sorber coupled to the polymerization reactor, the sorber positioned downstream from the polymerization reactor.

Embodiment F9. The process according to any one of Embodiments F2-F8, wherein, prior to removing the solid substrate comprising sorbed polymerization catalyst from the reaction product mixture by the solid-liquid separation, the process further comprises: introducing the reaction product mixture to a sorber coupled to the polymerization reactor, the sorber positioned downstream from the polymerization reactor.

Embodiment F10. The process according to any one of Embodiments F2-F9, wherein introducing the polymerization catalyst with the isobutylene comprises:
introducing the polymerization catalyst directly to the polymerization reactor;
introducing the polymerization catalyst to a feed comprising the isobutylene prior to entering the polymerization reactor; or
a combination thereof.

Embodiment F11. The process according to any one of Embodiments F1-F10, wherein:
removing the solid substrate comprising sorbed polymerization catalyst from the reaction product mixture by solid-liquid separation forms an HR-PIB containing filtrate; and
a halogen content in the HR-PIB containing filtrate is less than 100 ppm.

Embodiment F12. The process according to any one of Embodiments F1-F11, wherein after removing the solid substrate comprising sorbed polymerization catalyst by the solid-liquid separation, the process further comprises:
removing unreacted isobutylene from the reaction product mixture; and
removing oligomeric coproducts from the reaction product mixture to yield the HR-PIB.

Embodiment F13. The process according to any one of Embodiments F1-F12, the polymerization catalyst comprises a gaseous Lewis acid catalyst.

Embodiment F14. The process according to any one of Embodiments F1-F13, wherein the solid substrate comprises sorbed complexing agent.

Embodiment F15. The process according to any one of Embodiments F1-F14, wherein the polymerization catalyst comprises a pre-formed solid catalyst comprising a solid impregnated with liquid Lewis acid catalyst complex.

Embodiment F16. The process according to any one of Embodiments F1-F15, wherein the polymerization catalyst comprises a liquid Lewis acid catalyst complex, the liquid Lewis acid catalyst complex comprising:
the Lewis acid catalyst, the Lewis acid catalyst comprising a fluorine-containing material, a chlorine-containing material, or combinations thereof;
a complexing agent comprising an oxygen-containing compound, the oxygen-containing compound free of beta-hydrogen atoms; or
a combination thereof.

Embodiment F17. The process according to any one of Embodiments F1-F16, wherein the process further comprises one or more operations of any one of Embodiments A1-A44.

Embodiment G1. A process for producing HR-PIB, the process comprising:
feeding an isobutylene-containing stream into a polymerization reactor;
injecting an amount of polymerization catalyst into the polymerization reactor to form a mixture comprising isobutylene and polymerization catalyst, the amount of the polymerization catalyst sufficient to catalyze an isobutylene polymerization reaction to form HR-PIB, the polymerization catalyst comprising a Lewis acid catalyst;
sorbing the polymerization catalyst onto a solid substrate, the resultant solid substrate comprising sorbed polymerization catalyst having a concentration of the polymerization catalyst that is about 1 wt % or more (calculated as wt % of Lewis acid catalyst) based on a total wt % of the solid substrate comprising sorbed polymerization catalyst, the total wt % of the solid substrate comprising sorbed polymerization catalyst equal to 100 wt %, wherein sorbing the polymerization catalyst onto the solid substrate occurs before, during, and/or after the isobutylene polymerization reaction; and
removing the solid substrate comprising sorbed polymerization catalyst from the mixture by solid-liquid separation.

Embodiment G2. The process according to Embodiment G1, wherein sorbing the polymerization catalyst onto the solid substrate occurs before the isobutylene polymerization reaction by:
sorbing polymerization catalyst onto the solid substrate to form a pre-formed solid catalyst prior to its introduction into the polymerization reactor; and then feeding the pre-formed solid catalyst into the polymerization reactor.

Embodiment G3. The process according to any one of Embodiments G1-G2, wherein:
sorbing the polymerization catalyst onto the solid substrate occurs during the isobutylene polymerization reaction by feeding the solid substrate into the polymerization reactor; and/or
sorbing the polymerization catalyst onto the solid substrate occurs after the isobutylene polymerization reaction by a method comprising:
   removing the mixture from the polymerization reactor prior to the solid-liquid separation;
   introducing the mixture to a sorber unit; and
   adding the solid substrate to the sorber unit to contact and sorb polymerization catalyst from the mixture.

Embodiment G4. The process according to any one of Embodiments G1-G3, wherein the process further comprises one or more operations of any one of Embodiments A1-A44.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), may be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

“Contacting” and “combining” may be used herein to describe systems, compositions, and methods in which the materials or components are contacted or combined together in any suitable order, in any suitable manner, and for any suitable length of time, unless otherwise specified. For example, the materials or components may be blended, mixed, slurried, dissolved, reacted, treated, impregnated, compounded, or otherwise contacted or combined in some other suitable manner or by any suitable method or technique.

Generally, groups of elements are indicated using the numbering scheme indicated in the version of the periodic table of elements published in Chemical and Engineering News, 63 (5), 27, 1985. In some instances, a group of elements may be indicated using a common name assigned to the group; for example, alkali metals for Group 1 elements, alkaline earth metals for Group 2 elements, transition metals for Group 3-12 elements, and halogens or halides for Group 17 elements.

The term “olefin” is used herein in accordance with the definition specified by IUPAC: acyclic and cyclic hydrocarbons having one or more carbon-carbon double bonds apart from the formal ones in aromatic compounds.

In the foregoing, reference is made to embodiments of the disclosure. However, it should be understood that the disclosure is not limited to specific described embodiments. Instead, any combination of the features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the foregoing embodiments, features, aspects, implementations, and advantages are merely illustrative and are not considered elements or limitations of the appended claims except where explicitly recited in a claim(s). Likewise, reference to “the disclosure” shall not be construed as a generalization of any inventive subject matter described herein and shall not be considered to be an element or limitation of the appended claims except where explicitly recited in a claim(s).

As is apparent from the foregoing general description and the specific embodiments, while forms of the embodiments have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a formulation, a composition, an element or a group of elements is preceded with the transitional phrase “comprising,” it is understood that we also contemplate the same formulation, composition or group of elements with transitional phrases “consisting essentially of,” “consisting of,” “selected from the group of consisting of,” or “Is” preceding the recitation of the formulation, composition, element, or elements and vice versa, for example, the terms “comprising,” “consisting essentially of,” “consisting of” also include the product of the combinations of elements listed after the term.

References cited herein are incorporated by reference herein in their entirety to indicate the state of the art as of their publication or filing date and it is intended that this information may be employed herein, if desired, to exclude specific aspects that are in the prior art.

For purposes of this present disclosure, and unless otherwise specified, all numerical values within the detailed description and the claims herein are modified by “about” or “approximately” the indicated value, and consider experimental error and variations that would be expected by a person having ordinary skill in the art. It will be further understood that there are a number of values disclosed therein, and that each value is also herein disclosed as “about” that particular value in addition to the value itself. In embodiments, use of the term “about” may refer to ±20% of the stated value, ±15% of the stated value, ±10% of the stated value, ±5% of the stated value, ±3% of the stated value, ±2% of the stated value, or ±1% of the stated value.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited. For example, by disclosing a temperature of from 70° C. to 80° C., an intent is to recite individually 70° C., 71° C., 72° C., 73° C., 74° C., 75° C., 76° C., 77° C., 78° C., 79° C., and 80° C., including any sub-ranges and combinations of sub-ranges encompassed therein such that any of the foregoing numbers may be used singly to describe an open-ended range or in combination to describe a close-ended range. Moreover, all numerical end points of ranges disclosed herein are approximate, unless excluded by proviso. As a representative example, if one or more operations in the processes described herein may be conducted at a temperature in a range from 10° C. to 75° C., this range should be interpreted as encompassing temperatures in a range from “about” 10° C. to “about” 75° C. As another example, when a chemical moiety having a certain number of carbon atoms is disclosed or claimed, the intent is to disclose or claim individually every possible number that such a range could encompass, consistent with the disclosure herein. For example, the disclosure that a moiety is a C1 to C18 hydrocarbyl group, or in alternative language, a hydrocarbyl group having from 1 to 18 carbon atoms, refers to a moiety that may have 1, 2, 3, 4, 5, 6, 7, 8, 9, 10, 11, 12, 13, 14, 15, 16, 17, or 18 carbon atoms, as well as any range between these two numbers (for example, a C₁ to C₈ hydrocarbyl group), and also including any combination of ranges between these two numbers (for example, a C2-C4 and a C12-C16 hydrocarbyl group).

As used herein, the indefinite article “a” or “an” shall mean “at least one” unless specified to the contrary or the context clearly indicates otherwise. For example, embodiments comprising “a polymerization catalyst” include embodiments comprising one, two, or more polymerization catalysts, unless specified to the contrary or the context clearly indicates only one polymerization catalyst is included.

While the foregoing is directed to embodiments of the present disclosure, other and further embodiments of the disclosure may be devised without departing from the basic scope thereof, and the scope thereof is determined by the claims that follow.

What is claimed is:

1. A process for producing highly reactive polyisobutylene (HR-PIB), the process comprising:
introducing a polymerization catalyst with isobutylene to form a mixture comprising the isobutylene and the polymerization catalyst, the polymerization catalyst comprising a Lewis acid catalyst;
reacting the mixture to form a reaction product mixture comprising an HR-PIB;
sorbing the polymerization catalyst onto a solid substrate, the resultant solid substrate comprising sorbed polymerization catalyst having a concentration of the polymerization catalyst that is about 1 wt % or more (calculated as wt % of Lewis acid catalyst) based on a total wt % of the solid substrate comprising sorbed polymerization catalyst, the total wt % of the solid substrate comprising sorbed polymerization catalyst equal to 100 wt %; and
removing the solid substrate comprising sorbed polymerization catalyst from the reaction product mixture by solid-liquid separation.

2. The process according to claim 1, wherein sorbing the polymerization catalyst onto the solid substrate occurs:
in a polymerization reactor;
upstream of a polymerization reactor;
downstream of a polymerization reactor; or
combinations thereof.

3. The process according to claim 2, wherein the solid substrate is introduced into the polymerization reactor and contacts the reaction product mixture in the polymerization reactor.

4. The process according to claim 2, wherein:
the solid substrate and the polymerization catalyst are co-fed to the polymerization reactor in a single stream;
the solid substrate is separately added into the polymerization reactor after at least a portion of the HR-PIB is formed; or
a combination thereof.

5. The process according to claim 2, wherein introducing the polymerization catalyst with the isobutylene comprises:
introducing the polymerization catalyst into the polymerization reactor as a liquid BF₃·MeOH catalyst complex.

6. The process according to claim 2, wherein the polymerization catalyst and the solid substrate are co-fed into the polymerization reactor as separate streams.

7. The process according to claim 2, wherein the process further comprises:
removing the reaction product mixture comprising the HR-PIB from the polymerization reactor; and then
introducing the solid substrate with the reaction product mixture after removing the reaction product mixture from the polymerization reactor and prior to removing the solid substrate comprising sorbed polymerization catalyst from the reaction product mixture by the solid-liquid separation.

8. The process according to claim 2, wherein:
a first portion of the solid substrate is co-fed with the polymerization catalyst to the polymerization reactor; and
a second portion of the solid substrate is introduced to the reaction product mixture in a sorber coupled to the polymerization reactor, the sorber positioned downstream from the polymerization reactor.

9. The process according to claim 2, wherein, prior to removing the solid substrate comprising sorbed polymerization catalyst from the reaction product mixture by the solid-liquid separation, the process further comprises:
introducing the reaction product mixture to a sorber coupled to the polymerization reactor, the sorber positioned downstream from the polymerization reactor.

10. The process according to claim 2, wherein introducing the polymerization catalyst with the isobutylene comprises:
introducing the polymerization catalyst directly to the polymerization reactor;
introducing the polymerization catalyst to a feed comprising the isobutylene prior to entering the polymerization reactor; or
a combination thereof.

11. The process according to claim 1, wherein:
removing the solid substrate comprising sorbed polymerization catalyst from the reaction product mixture by solid-liquid separation forms an HR-PIB containing filtrate; and
a halogen content in the HR-PIB containing filtrate is less than 100 ppm.

12. The process according to claim 1, wherein after removing the solid substrate comprising sorbed polymerization catalyst by the solid-liquid separation, the process further comprises:
removing unreacted isobutylene from the reaction product mixture; and
removing oligomeric coproducts from the reaction product mixture to yield the HR-PIB.

13. The process according to claim 1, the polymerization catalyst comprises a gaseous Lewis acid catalyst.

14. The process according to claim 13, wherein the solid substrate comprises sorbed complexing agent.

15. The process according to claim 1, wherein the polymerization catalyst comprises a pre-formed solid catalyst comprising a solid impregnated with liquid Lewis acid catalyst complex.

16. The process according to claim 1, wherein the polymerization catalyst comprises a liquid Lewis acid catalyst complex, the liquid Lewis acid catalyst complex comprising:
the Lewis acid catalyst, the Lewis acid catalyst comprising a fluorine-containing material, a chlorine-containing material, or combinations thereof;
a complexing agent comprising an oxygen-containing compound, the oxygen-containing compound free of beta-hydrogen atoms; or
a combination thereof.

17. A process for producing HR-PIB, the process comprising:
feeding an isobutylene-containing stream into a polymerization reactor;
injecting an amount of polymerization catalyst into the polymerization reactor to form a mixture comprising isobutylene and polymerization catalyst, the amount of the polymerization catalyst sufficient to catalyze an isobutylene polymerization reaction to form HR-PIB, the polymerization catalyst comprising a Lewis acid catalyst;
sorbing the polymerization catalyst onto a solid substrate, the resultant solid substrate comprising sorbed polymerization catalyst having a concentration of the polymerization catalyst that is about 1 wt % or more (calculated as wt % of Lewis acid catalyst) based on a total wt % of the solid substrate comprising sorbed polymerization catalyst, the total wt % of the solid substrate comprising sorbed polymerization catalyst equal to 100 wt %, wherein sorbing the polymerization catalyst onto the solid substrate occurs before, during, and/or after the isobutylene polymerization reaction; and
removing the solid substrate comprising sorbed polymerization catalyst from the mixture by solid-liquid separation.

18. The process according to claim 17, wherein sorbing the polymerization catalyst onto the solid substrate occurs before the isobutylene polymerization reaction by:
sorbing polymerization catalyst onto the solid substrate to form a pre-formed solid catalyst prior to its introduction into the polymerization reactor; and then
feeding the pre-formed solid catalyst into the polymerization reactor.

19. The process according to claim 17, wherein:
sorbing the polymerization catalyst onto the solid substrate occurs during the isobutylene polymerization reaction by feeding the solid substrate into the polymerization reactor; and/or
sorbing the polymerization catalyst onto the solid substrate occurs after the isobutylene polymerization reaction by a method comprising:
removing the mixture from the polymerization reactor prior to the solid-liquid separation;
introducing the mixture to a sorber unit; and
adding the solid substrate to the sorber unit to contact and sorb polymerization catalyst from the mixture.

20. A processing plant for producing HR-PIB, comprising:
a tubular loop reactor configured to:
perform isobutylene polymerization;
form a reaction product mixture comprising HR-PIB; and
discharge the reaction product mixture comprising the HR-PIB;
a tubular loop sorber coupled to the tubular loop reactor and positioned downstream from the tubular loop reactor, the tubular loop sorber equipped with one or more in-line circulation pumps and a multi-pass tube-in-shell heat exchanger, the tubular loop sorber configured to:
receive the reaction product mixture from the tubular loop reactor;
facilitate sorption of a polymerization catalyst present in the reaction product mixture onto a solid substrate; and
discharge the reaction product mixture comprising the HR-PIB and the solid substrate comprising sorbed polymerization catalyst;
a solid-liquid separation unit coupled to the tubular loop sorber and positioned downstream from the tubular loop sorber, the solid-liquid separation unit configured to:
separate the solid substrate comprising sorbed polymerization catalyst from the reaction product mixture;
discharge the solid substrate comprising sorbed polymerization catalyst; and
discharge an HR-PIB containing filtrate.
